(19) United States
(12) Patent Application Publication
(10) Pub. No.: US 2026/0157411 A1
(43) Pub. Date: Jun. 11, 2026

(54) Emulsion-Based Food Products Comprising Plant-Based Proteins And Fiber

(71) Applicant: H.J. Heinz Company Brands LLC, Pittsburgh, PA (US)

(72) Inventors: Gonçalo Luís Melo Santa, Nijmegen (NL); Maycirit Aguirre Cardenas, Utrecht (NL); Jonathan Wiese, Chicago, IL (US)

(21) Appl. No.: 18/708,856

(22) PCT Filed: Nov. 17, 2022
(86) PCT No.: PCT/US2022/050266

§ 371 Date: May 9, 2024

Related U.S. Application Data
(60) Provisional application No. 63/280,489, filed on Nov. 17, 2021.
(60) Provisional application No. 63/397,663, filed on Aug. 12, 2022.

(51) Int. Cl. A23L 27/60; A23L 29/212; A23L 33/185; A23L 33/21

(52) U.S. Cl. CPC A23L 27/60; A23L 29/212; A23L 33/185; A23L 33/21

(57) ABSTRACT

Emulsions and emulsion-based food products are described herein. Methods of making emulsions and emulsion-based food products are also provided. The emulsions and emulsion-based food products contain plant-based protein and plant-based fiber. In one particular approach, the plant-based fiber includes flaxseed fiber, and the plantbased protein includes faba bean protein. The combination of faba bean protein and flaxseed fiber provides desired creamy texture and emulsion stability to the emulsions and emulsion-based food products.

### CROSS REFERENCE TO RELATED APPLICATIONS

This application claims the benefit of U.S. Provisional Application No. 63/397,663, filed Aug. 12, 2022, and U.S. Provisional Application No. 63/280,489, filed Nov. 17, 2021, both of which are incorporated herein by references in their entireties.

### FIELD

The field relates generally to emulsions and emulsion-based food products, and more specifically to emulsions and emulsion-based food products containing plant-based protein and fiber.

### BACKGROUND

Many conventional condiments are oil-in-water emulsions in which egg protein functions as the emulsifier. Exemplary condiments include mayonnaise products, dips, salad dressings, as well as other pourable or spoonable products.

In recent years, there's been increased and significant consumer demand for vegan and vegetarian food products that lack certain animal-based ingredients, such as egg, dairy ingredients, or meat. Condiments, such as mayonnaise-type products, lacking egg-based proteins have been a significant part of this demand. The demand for these products has not just been by vegan consumers, but also by consumers with allergies to egg, and by other consumers looking to reduce but not necessarily eliminate their consumption of animal products.

Conventional mayonnaise products usually contain egg yolk, oil, water, vinegar, lemon juice, and seasonings. When egg is removed from an emulsion-based food product, the functionality of the egg must be replaced by another ingredient. For example, egg yolk contains a natural emulsifier, lecithin. Therefore, removal of egg from an emulsion-based food product requires inclusion of an ingredient that functions as an emulsifier while also not providing undesired functionalities or flavors to the product. Incorporating chemical emulsifiers can impart off flavors in the food product and consumers often perceive such chemical emulsifiers as artificial and, thus, as undesirable.

### BRIEF DESCRIPTION OF THE DRAWINGS

FIG. 1 is a flow chart generally illustrating the preparation of an emulsion in accordance with an exemplary embodiment.

FIG. 2 includes light microscope images of a mayonnaise-type product produced according to an exemplary embodiment.

FIG. 3 includes light microscope images of a mayonnaise-type product produced according to an exemplary embodiment.

FIG. 4 includes light microscope images of a mayonnaise-type product produced according to an exemplary embodiment.

FIG. 5 includes light microscope images of a mayonnaise-type product.

FIG. 6 includes light microscope images of a mayonnaise-type product.

FIG. 7 includes light microscope images of a mayonnaise-type product.

FIG. 8 includes light microscope images of a mayonnaise-type product.

FIG. 9 includes light microscope images of a mayonnaise-type product.

FIG. 10 is a graph of linear visco-elastic data for mayonnaise-type products.

FIG. 11 is a chart of median and mean particle sizes of different plant-based mayonnaise-type products as compared to egg-based mayonnaise.

FIG. 12 is a graph of the particle size distribution of different plant-based mayonnaise-type products as compared to egg-based mayonnaise.

FIG. 13 is a graph of shear rate ramp values of different plant-based mayonnaise-type products as compared to egg-based mayonnaise.

FIG. 14 is a chart of shear stress (Pa) values of different plant-based mayonnaise-type products as compared to egg-based mayonnaise.

FIG. 15 is a chart of median and mean particle sizes of plant-based mayonnaise-type products with and without starch.

FIG. 16 is a graph of the particle size distribution of mayonnaise-type products with and without starch.

FIG. 17 is a graph of linear visco-elastic data for mayonnaise-type products with and without starch.

FIG. 18 is a chart of median and mean particle sizes of low oil plant-based mayonnaise-type products.

FIG. 19 is a chart of median and mean particle sizes of high oil plant-based mayonnaise-type products.

FIG. 20 is a graph of the particle size distribution of low oil mayonnaise-type products.

FIG. 21 is a graph of the particle size distribution of high oil mayonnaise-type products.

FIG. 22 is a graph of linear visco-elastic data for low oil mayonnaise-type products.

FIG. 23 is a graph of linear visco-elastic data for high oil mayonnaise-type products.

FIG. 24 is a chart of median and mean particle sizes of plant-based mayonnaise-type products.

FIG. 25 is a graph of the particle size distribution of mayonnaise-type products.

FIG. 26 is a graph of linear visco-elastic data for mayonnaise-type products.

FIG. 27 is a chart of median and mean particle sizes of plant-based mayonnaise-type products.

FIG. 28 is a graph of the particle size distribution of mayonnaise-type products.

FIG. 29 is a graph of linear visco-elastic data for mayonnaise-type products.

FIG. 30 is a chart of median and mean particle sizes of plant-based mayonnaise-type products.

FIG. 31 is a graph of the particle size distribution of mayonnaise-type products.

FIG. 32 is a graph of linear visco-elastic data for mayonnaise-type products.

FIG. 33 is a chart of median and mean particle sizes of plant-based mayonnaise-type products.

FIG. 34 is a graph of the particle size distribution of mayonnaise-type products.

FIG. 35 is a graph of linear visco-elastic data for mayonnaise-type products.

The terms and expressions used herein have the ordinary technical meaning as is accorded to such terms and expressions by persons skilled in the technical field as set forth above except where different specific meanings have otherwise been set forth herein.

### DETAILED DESCRIPTION

Described herein are emulsions and emulsion-based food products containing plant-based ingredients. It has been unexpectedly found that a combination of plant-based protein and plant-based fiber can provide an emulsion-based food product with characteristics consistent with consumer expectations of a comparable emulsion-based food product containing animal-based ingredients. For example, mayonnaise- or dressing-type food products containing the plant-based ingredients described herein have a smooth and creamy texture and emulsion stability consistent with consumer expectations of conventional egg-based mayonnaise and dressing products.

In one approach, the emulsion and emulsion-based food products are plant-based products. As used herein, the term “plant-based” refers to a product or ingredient that is free of animal-based ingredients, such as dairy proteins or egg-based emulsifiers, and instead includes an ingredient derived from a plant.

In one particular approach, it has been found that only certain plant-based proteins, including faba bean, pea protein, and potato proteins, have sufficient emulsification capacity to make a stable oil-in-water emulsion. In one aspect, these proteins are suitable for use in emulsion-based food products having a relatively high oil content (e.g., about 50 to about 80% oil). In one aspect, the food product is a mayonnaise or dressing-type food product.

It has also been found that a combination of the plant-based protein and flaxseed fiber provides a suitably stable and/or small oil droplet size and good emulsion stability. In contrast, it has been found that failure to use a combination of the plant-based protein and flaxseed fiber can result in poor emulsion stability and large oil droplet size.

It has further been found that the combination of faba bean protein and flaxseed fiber provides more stable oil-in-water emulsions than other plant-based proteins, such as chickpea, even when those proteins are used in combination with flaxseed fiber.

One exemplary flaxseed fiber useful herein includes Hi-Smooth from Hi-Food Spa. One exemplary faba bean product includes VITESSENCE™ Pulse 3600 (also known as VITESSENCE™ Prista P 360) (containing 60% crude protein) from Ingredion. Other plant-based proteins with some suitability for the present emulsions and methods include pea protein (for example, VITESSENCE™ Pulse 1550 (55% crude protein) or VITESSENCE™ 1803 (also known as VITESSENCE™ Prista P 155) (containing 77.8% crude protein) from Ingredion, and potato protein (for example, Solanic 300 (containing 90% crude protein) from Avebe). In general, the pea and/or potato proteins may be included in the same amounts described herein for the faba bean protein or may be combined with faba bean protein in the emulsion-based food products. At least in some approaches, plant proteins suitable for use in the emulsion-based food products should have an isoelectric point higher than the pH of the emulsion-based food product.

Accordingly, at least in some embodiments, the plant-based protein useful herein is faba bean protein, potato protein, pea protein, or a combination thereof and the plant-based fiber is flaxseed fiber. In some approaches, the plant-based protein can be in the form of an isolate, a concentrate, or a flour, though the precise form of the plant-based protein is not believed to be particularly limited. Generally, protein isolates have a higher crude protein content than protein concentrates. The amount of crude protein in a plant-based protein ingredient may depend on the form of the protein-containing ingredient (e.g., whether the ingredient is in the form of an isolate, a concentrate, or a flour). Thus, for purposes herein, the amount of crude protein is the amount of protein contributed by any protein-containing ingredient. The amount of crude protein in a plant-based protein ingredient or in the emulsions may be measured by the Association of Official Analytical Chemists (AOAC) Official Method 992.15 (which is incorporated herein by reference in its entirety). For purposes herein, the term “plant-based protein” refers to a protein ingredient having at least 50% crude protein by dry weight.

Generally, the amount of the plant-based protein (and particularly faba bean protein as the plant-based protein) needed for a given emulsion-based product may be inversely related to the oil content of the product. For instance, higher oil contents require less plant-based protein content, and lower oil contents require higher plant-based protein content to provide a stable emulsion. In some approaches, using high amounts of plant-based protein at high oil content can cause the emulsion to look thin and to cause gelation, so lower amounts of plant-based protein may be preferred at higher oil content.

In one approach, the plant-based protein (i.e., faba bean protein) is present in an amount within the range of about 0.2% to about 1.5%, in another aspect about 0.4% to about 1.5%, based on the total weight of the emulsion-based food product, when the product includes about 60 to about 80 percent oil.

In one approach, the plant-based protein (i.e., faba bean protein, potato, and/or pea protein) is present in an amount within the range of about 0.2% to about 1.5%, in another aspect about 0.4% to about 1.5%, in another aspect about 0.5 to about 1.0%, based on the total weight of the emulsion-based food product, when the product includes about 40% to about 80% oil, in another aspect about 50% to about 80%, in another aspect about 60% to about 80% oil, and in another aspect about 60 to about 75% oil.

In another approach, the fiber generally provides two main functions in the emulsion-based food product. First, the fiber assists in stabilizing the emulsion. Second, the fiber adds thickness/viscosity to the emulsion-based food product. In one approach, the plant-based fiber (i.e., flaxseed fiber) is present in an amount within the range of about 0.1 wt % to about 1.5 wt % fiber, in another aspect about 0.5% to about 1.25%, and in another aspect about 0.6% to about 1.0%, based on the total weight of the emulsion-based food product, when the product includes about 50% to about 80% oil, in another aspect about 60% to about 80% oil, and in another aspect about 60 to about 75% oil.

For emulsion-based food products with an intermediate oil content (e.g., about 40 to about 60 percent oil), generally an intermediate amount of plant-based fiber is required. For instance, about 1.5 to about 3.0% fiber may be required.

The oil used herein can be any food grade oil that is liquid at refrigeration temperatures. Suitable oils include, for example, rapeseed oil, canola oil, soybean oil, safflower oil, sunflower oil, peanut oil, corn oil, olive oil, and combinations thereof.

In some approaches, the plant-based fiber may include a hydrocolloid, such as xanthan gum, guar gum, and locust bean gum in addition to the flaxseed fiber. However, it has been found that hydrocolloids are not suitable replacements for flaxseed fiber. For example, it has been found that inclusion of xanthan gum can result in an undesirably high storage modulus (G′) values and inclusion of guar gum can result in coalescence of the oil droplets. Accordingly, at least in some embodiments, the emulsion-based food products specifically do not include any hydrocolloids or specifically xanthan and/or guar gum.

In some approaches, the emulsion-based food product may include no further texturizing agents. By one approach, the emulsion is free of starch. By the term “free of starch,” it is meant that the emulsion-based food product includes less than a functional (e.g., thickening) amount of starch. By one approach, the emulsion contains less than 1 percent starch. By another approach, the emulsion contains less than 0.5 percent starch. By another approach, the emulsion contains less than 0.1 percent starch. By another approach, the emulsion contains no starch.

However, in other approaches, the emulsion-based food product may comprise starch or other texturizing agents, particularly when the product includes lesser amounts of oil. For example, for a mayonnaise-type product having an oil content of less than 65%, it may be desirable to include a low amount of starch for additional viscosity, such as about 0.5% to about 2% starch, in another aspect about 0.75% to about 1.5% starch, and in another aspect about 1.0% to about 1.5% starch. However, even with the addition of starch, the plant-based protein and plant-based fiber should still be included and in the amounts described herein.

If the emulsion-based food product comprises starch or other viscosity-building ingredient, lesser amounts of the plant-based fiber may be included despite having a lower oil content. For example, at least in some embodiments, particularly in the range of about 40% to about 65% oil, inclusion of a starch can improve the storage modulus (G′) value and emulsion stability. Accordingly, for emulsion-based food products comprising about 50% to about 65% oil, the emulsion-based food product may further comprise about 0.5% to about 3% starch, in another aspect about 0.5 to about 2.5% starch, in another aspect about 0.5 to about 2% starch. The emulsion-based food product also comprises a plant-based protein (i.e., faba bean protein, potato, and/or pea protein) in an amount within the range of about 0.1% to about 1.5%, in another aspect about 0.2% to about 1.5%, in another aspect about 0.4% to about 1.5%, in another aspect about 0.5 to about 1.0%, based on the total weight of the emulsion-based food product, and plant-based fiber (i.e., flaxseed fiber) in an amount within the range of about 0.1 wt % to about 1.5 wt % fiber, in another aspect about 0.5% to about 2%, in another aspect about 0.5% to about 1.5%, in another aspect about 0.5% to about 1.25%, and in another aspect about 0.6% to about 1.0%, based on the total weight of the emulsion-based food product.

Suitable starches may include modified, native, and pregelatinized starches. For example, the starch may be a cold water-swelling (CWS) starch such as Starch NOVATION® 4300 (Ingredion) or MERIGEL® 341 (Tate & Lyle).

The emulsion-based food products further include water, generally in an amount of about 15% to about 45%, in another aspect about 15% to about 40%, in another aspect about 15% to about 35%, in another aspect about 15% to about 30%.

In one particular approach, a plant-based, mayonnaise-type product in the form of an oil-in-water emulsion, the emulsion comprising water; about 60 wt. % to about 80 wt. % oil; 0.4 wt. % to about 1.5 wt. % plant-based protein, wherein the plant-based protein includes one or more of faba protein, potato protein, and pea protein; and 0.1 wt. % to about 1.5 wt. % flaxseed fiber.

In some approaches, the emulsion-based food product has a storage modulus (G′) value of about 1000 Pa to about 2000 Pa, in another aspect about 1200 Pa to about 1800 Pa, in another aspect about 1300 Pa to about 1600 Pa, and in another aspect about 1500 Pa to about 1600 Pa. It has been found herein that emulsion-based food products having a storage modulus in the described ranges are particularly suitable for mayonnaise- or dressing-type food products. A Kinexus rheometer can be used to measure the amplitude sweep, yield stress, and shear rate ramp of the samples. The amplitude sweep test measures the Linear Visco-Elastic region (LVER) of the sample and to analyze its robustness. The shear rate ramp test determines the influence of viscosity with a logarithmic increase of shear rate. Yield stress is measured by determining the stress at which the viscosity peak is observed. Prior to the viscosity peak, the material is undergoing elastic deformation where the sample stretches and the peak in viscosity represents the point at which the elastic structure breaks down (yields) and the material starts to flow. The Kinexus rheometer is used to measure the amplitude sweep of the samples using a cone-plate geometry (CP4/40 SC0095 SS). Measurements are performed at 25° C. The storage modulus is measured over a range of shear strain from 0.1% to 100% at a set frequency of 1 Hz. Because G′ (elastic modulus) is a measure of structural integrity, any drop in G′ indicates a breakdown of material structure and hence the onset of non-linearity.

In some examples, the emulsion-based food product further includes an acidulant in an amount effective to provide a pH of the food product of about 2.5 to about 4.0, in another aspect about 2.8 to about 4.0, in another aspect about 2.9 to about 3.5, and in another aspect about 2.9 to about 3.1. Any suitable acidulant or combination of acidulants may be used. In one example, the acidulant comprises one or more of citric acid, malic acid, acetic acid (such as in the form of vinegar), phosphoric acid, sorbic acid, and lactic acid. In addition to lowering the pH, the inclusion of an edible acidulant (i.e., a food-grade acidulant), or a mixture of edible acidulants, may contribute microbial stability and impart desirable flavor to the emulsion.

In some embodiments, the emulsion-based food product may further include additional components. Examples of additional components include one or more of a sweetener, salt, an antimicrobial agent, flavoring agents (e.g., mustard, herbs, and spices), and colors. Sweeteners, such as sucrose, dextrose, fructose, glucose, mannose, galactose, maltose, corn syrup, and synthetic sweeteners, may be employed, if desired.

The emulsion-based food products described herein may be, for example, in the form of a mayonnaise-type product, a dressing, a sauce, or the like. The emulsion-based food products may also be added as ingredients to bakery and dessert products.

At least in some approaches, these emulsion-based food products are characterized by being in the form of an oil-in-water emulsion that remains stable during the product shelf-life, such as at least about 1 month, in another aspect at least about 2 months, in another aspect at least about 3 months, and in another aspect at least about 6 months, when stored at 20° C.

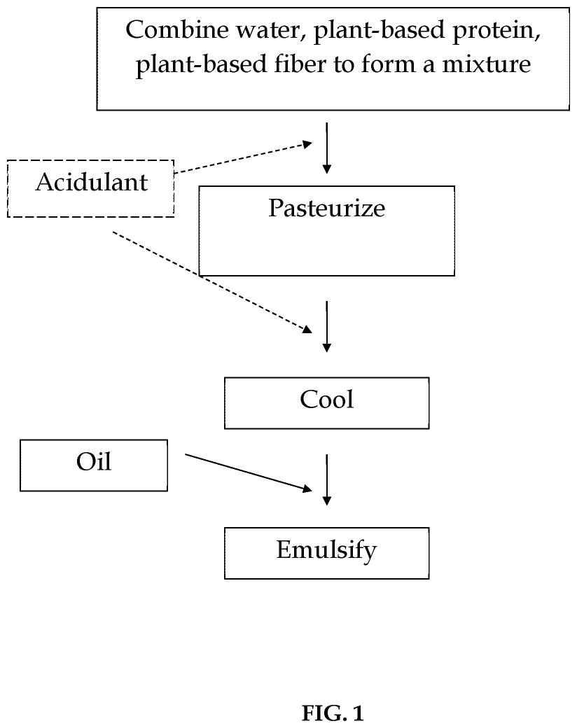

FIG. 1 provides a flow chart illustrating a process in accordance with one embodiment presented herein. It has been found that preparing an emulsion under the conditions described herein provides a composition with improved creamy texture and emulsion stability. In this aspect, the process comprises combining water, plant-based protein (e.g., faba bean protein), and plant-based fiber (e.g., flaxseed fiber) to form a mixture. The mixture is then treated at a temperature and for a time effective to pasteurize the mixture. The acidulant may be added prior to or after the pasteurization process. The pasteurized mixture is then cooled. Then oil is added, after which the combination of the pasteurized mixture and oil is treated with an emulsification process. Other optional ingredients (e.g., salt, sugar) may be added at any step of the process.

In one approach, a method for preparing a plant-based, mayonnaise-type product in the form of an oil-in-water emulsion is provided. The method includes combining 0.4 wt. % to 1.5 wt. % plant-based protein, 0.1 wt. % to 1.5 wt. % flaxseed fiber, and water to provide a first mixture; adding 60 wt. % to 80 wt. % oil to the first mixture to provide a second mixture; and mixing the second mixture to produce an oil-in-water emulsion, wherein the plant-based protein includes one or more of faba protein, potato protein, and pea protein.

Generally, the emulsification process used is effective to provide a desired mean particle size (D4.3) or median particle size (D50). An Eyetech particle sizer can be used to measure the D3.2 and D4.3 values. D3.2 is the surface weighted average diameter, whereas D4.3 is the volume mean diameter. The mean and median particle sizes were measured using a Horiba LA-960 particle sizer. The graph is plotted with diameter in microns on the x-axis, and the y-axis is q %, which is the percentage in a given histogram channel. The mean particle size is the volume mean diameter, whereas the median size is the value where half of the population resides above this point and half resides below this point. The particle sizes include oil and other solids (e.g., flaxseed) present in the product. The particle size distribution may be monomodal or bimodal depending on the other ingredients included in the product.

In some approaches, the mean particle size is below about 100 microns, in another aspect below about 75 microns, in another aspect below about 50 microns, and in another aspect below about 45 microns. In other approaches, the mean particle size is about 1 micron to about 100 microns, in another aspect about 1 micron to about 75 microns, in another aspect about 1 micron to about 50 microns, and in another aspect about 1 micron to about 45 microns.

In some approaches, the median particle size is below about 50 microns, in another aspect below about 40 microns, in another aspect below about 30 microns, and in another aspect below about 25 microns. In other approaches, the median particle size is between about 1 micron to about 50 microns, in another aspect between about 1 micron to about 40 microns, in another aspect between about 1 micron to about 30 microns, and in another aspect between about 1 micron to about 25 microns.

For example, a batch or in-line high shear mixer or homogenizer may be used, such as a FrymaKoruma MaxxD. Conventional mayonnaise products are typically homogenized using a colloid mill. Homogenization by colloid mill provides low to medium shear. In another aspect, for example, high pressure homogenization may be used to provide further reduced mean oil droplet size.

The emulsion-based food product generally has a fat droplet size distribution that enables the emulsion-based food product to have an opaque appearance and a soft, smooth texture similar to a conventional mayonnaise or dressing product. The fat droplet size distribution may be observed by light microscopy or measured using a Bruker time-domain nuclear magnetic resonance droplet size analyzer (Bruker TD-NMR droplet size analyzer). A decay curve (intensity vs. time) of the NMR field may be used to derive the fat droplet size distributions.

When evaluated by light microscopy, it is generally preferred that the oil droplets do not exhibit coalescence, indicating emulsion instability. Though it is preferred that oil droplets be generally small in size, it has been found to be more important that the oil droplet size remain generally consistent (though not coalesced) over time during product storage.

For purposes herein, viscosity can be measured with a Brookfield viscometer RV (spindle 6) at 12 rpm for 30 seconds when the emulsion-based food product is at a temperature of 20° C. The viscosity measurement is taken 24 hours after the emulsification step. In one aspect, the emulsion or emulsion-based food product has a viscosity in the range of about 10,000 cP to about 85,000 cP, in another aspect about 15,000 cP to about 85,000 cP, in another aspect about 15,000 to about 60,000, in another aspect about 30,0000 cP to about 60,000 cP, in another aspect about 35,000 cP to about 55,000 cP. Viscosity can also be measured with a Brookfield viscometer HA (spindle 6) at 12 rpm for 30 seconds when the emulsion or emulsion-based food product is at a temperature of 20° C. The two viscosity measurement techniques using spindle 6 are expected to give similar results when using the same settings, with the primary difference being that the HA viscometer allows for a larger viscosity range. Viscosity can also be measured using a Brookfield viscometer HA (spindle 5) at 30 rpm for 30 seconds when the emulsion or emulsion-based food product is at a temperature of 20° C. The particular viscosity measurement technique used may depend on the viscosity of the emulsion or emulsion-based food product because the equipment differs in the ability to measure viscosity of lower or higher viscosity products. For example, a larger spindle generally allows for more coverage in terms of measuring high viscosity products.

In one approach, the emulsion or emulsion-based food product has a viscosity in the range of about 10,000 cP to about 85,000 cP, in another aspect about 15,000 cP to about 85,000 cP, in another aspect about 15,000 to about 60,000, in another aspect about 30,0000 cP to about 60,000 cP, in another aspect about 35,000 cP to about 55,000 cP measured with a Brookfield viscometer HA or RV (spindle 6) at 12 rpm for 30 seconds when the emulsion or emulsion-based food product is at a temperature of 20° C.

In another approach, the emulsion or emulsion-based food product has a viscosity in the range of about 10,000 cP to about 85,000 cP, in another aspect about 15,000 cP to about 85,000 cP, in another aspect about 15,000 to about 60,000, in another aspect about 30,0000 cP to about 60,000 cP, in another aspect about 35,000 cP to about 55,000 cP measured with a Brookfield viscometer HA (spindle 5) at 30 rpm for 30 seconds when the emulsion or emulsion-based food product is at a temperature of 20° C.

In some approaches, the plant-based protein may be the only emulsifier in the emulsion-based food product. In another aspect, the emulsion-based food product is free of animal-based emulsifiers, such as egg in any form, including egg yolk, egg-based lecithin, or whole egg. By the term “free of animal-based emulsifiers,” it is meant that the emulsion includes less than a functional (e.g., emulsifying) amount of animal-based emulsifier. By one approach, the emulsion-based food product contains less than 0.5 percent animal-based emulsifier. By another approach, the emulsion contains less than 0.1 percent animal-based emulsifier. By another approach, no animal-based emulsifier is included. The emulsion may also not include conventional emulsifiers, such as DATEM, or plant-based sources of lecithin.

In another aspect, the emulsion-based food product may include no protein other than the plant-based protein. In one aspect, the emulsion is free of any dairy proteins and meat proteins.

After the method described above, if desired, the emulsion can be used as a premix or intermediate to provide emulsion-based food products having a wide variety of fat contents. The emulsions can also be added to other types of food products, including bakery and dessert products.

The optional ingredients can be added by conventional mixing techniques and equipment. The pressure employed, the shear rate, and/or the time for mixing may vary widely dependent upon the particular equipment employed.

The emulsions and emulsion-based food products described herein may be prepared in batch, semi-continuous, or continuous processes.

These and other advantages of the emulsions and emulsion-based food products described herein will become apparent to those skilled in the art upon consideration of the present specification.

### EXAMPLES

### Example 1

To evaluate emulsion stability, mayonnaise-type formulations were tested that included flaxseed fiber with chickpea protein or faba bean protein. The mayonnaise-type products were prepared according to the formulations of Table 1.

The water phase of the mayonnaise-type products is prepared using a Silverson LM-A benchtop high shear mixer. Dry ingredients, including the plant-based protein, sugar, and salt, are mixed with water at about 2500-3000 rpm. Once there are no major visible lumps, the plant-based fiber (and any flavorings such as mustard) are added while the mixer is still on. The acidifying ingredients can be added at this stage as well. This mixture is then pasteurized in a jacketed heating vessel (OMVE MPV220). The water phase mixture is cooled down until reaching less than 26° C. If needed, acidifying ingredients can be added at this stage as well. The water phase and the oil are emulsified in a high shear emulsifier (FrymaKoruma MaxxD Lab) at 3000 rpm giving 30-40 seconds of recirculation time. The oil is added at a speed of 0.15-0.18 kg/s. If the formulation contains starch or other thickener, the thickener is mixed with ⅓ of the total amount of oil and added at the beginning of the emulsification process followed by the remaining oil. The present process is also used for the remaining examples.

TABLE 1

| | | Formula B: | Formula C: | |
|---|---|---|---|---|
| | Formula A: | Faba + | Faba + | Formula D: |
| | Faba + | Flax + | Higher | Chickpea + |
| | Flax | EDTA | Flax | Flax |
| | (wt. %) | (wt. %) | (wt. %) | (wt. %) |
| Sugar | 1.5 | 1.5 | 1.5 | 1.5 |
| Salt | 1.0 | 1.0 | 1.0 | 1.0 |
| Flavors | 0.04 | 0.04 | — | — |
| Mustard | — | — | 2.35 | 2.35 |
| Vinegar | 1.0 | 1.0 | 1.0 | 2.16 |
| (19.5%) | | | | |
| Lemon juice | 0.5 | 0.5 | 0.5 | 0.1 |
| concentrate | | | | |
| Ethylene- | — | 0.007 | — | — |
| diamine- | | | | |
| tetraacetic | | | | |
| acid (EDTA) | | | | |
| Flaxseed | 0.4 | 0.4 | 0.8 | 0.4 |
| fiber | | | | |
| (Hi-Smooth | | | | |
| from Hi-Food) | | | | |
| Faba bean | 0.5 | 0.5 | 0.5 | — |
| protein | | | | |
| (Vitessence | | | | |
| 3600 from | | | | |
| Ingredion) | | | | |
| Chickpea | — | — | — | 0.8 |
| protein | | | | |
| (Chickpea | | | | |
| S930 from | | | | |
| Chick P) | | | | |
| Water | 25.06 | 25.05 | 22.35 | 19.69 |
| Rapeseed oil | 70.0 | 70.0 | 70.0 | 72.0 |
| | 100.0 | 100.0 | 100.0 | 100.0 |

The samples were analyzed about one week after storage at 20° C.

The samples were tested to analyze the globule size under the microscope as well as particle size distribution. An emulsion stability test was performed by analyzing the samples before and after shaking for 2 hours at 300 rpm.

Visual Observation: Samples were visually observed for appearance and oil separation before and after shaking. Visible oil separation is indicative of an unstable emulsion that is unsuitable for use as a mayonnaise-type product.

For Formula A (Faba+Flax) and Formula B (Faba+Flax+EDTA), no oil separation was observed. After shaking, some minor oil separation was observed in both samples. Because the oil separation was minimal, these formulas were considered acceptable.

For Formula C (Faba+Higher Flax), no oil separation was observed before or after shaking. Formula C was considered acceptable.

For Formula D (Chickpea+Flax), no oil separation was observed but there was oil separation after shaking. Formula D was considered unacceptable.

Microscopy: A light microscope (magnification: 40×) was used to observe the samples before and after shaking to look for coalescence and globule size of oil droplets. Coalescence of the oil droplets is considered unacceptable, either before or after shaking. Large oil droplets are generally less desirable but may be acceptable if the oil droplet size is largely unchanged after shaking.

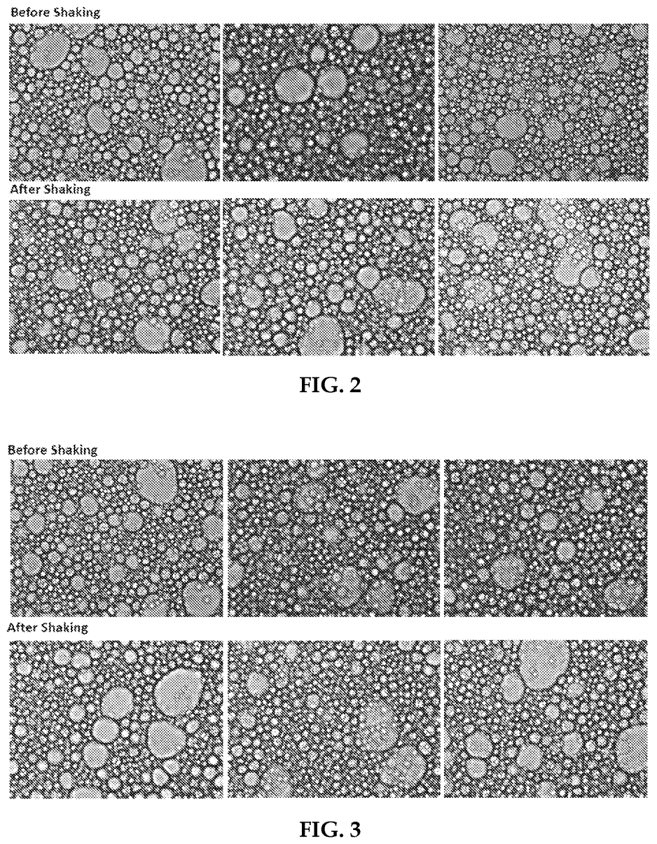

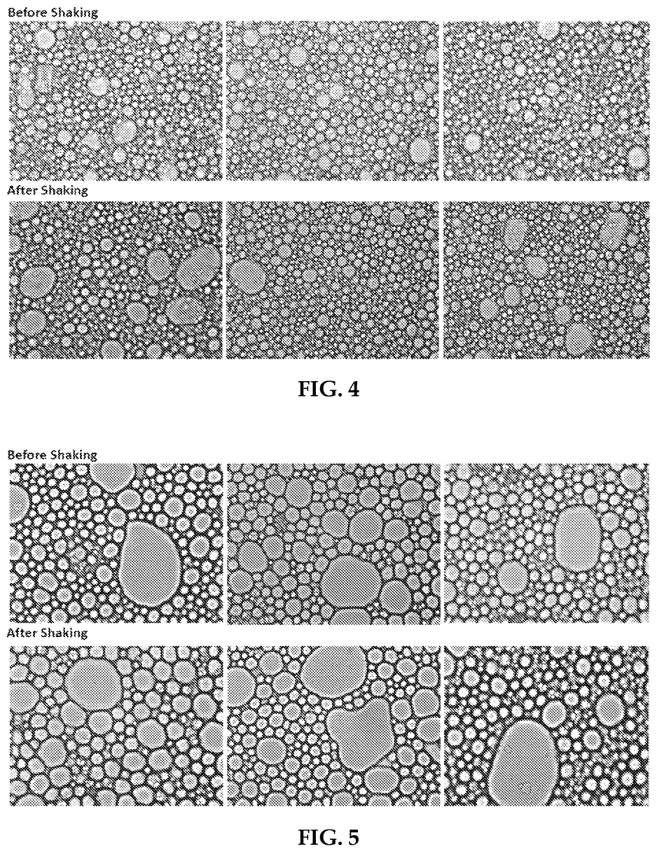

The light microscopy images are shown in FIGS. 2-5: Formula A is shown in FIG. 2, Formula B is shown in FIG. 3, Formula C is shown in FIG. 4, and Formula D is shown in FIG. 5. The following observations were made:
Formula A (Faba+flax): The oil globules were of acceptable size before and after shaking.
Formula B (Faba+flax+EDTA): The oil globules were of acceptable size before and after shaking.
Formula C (Faba+higher flax): The oil globules were of acceptable size before and after shaking
Formula D (Chickpea+flax): Coalescence was observed before and after shaking (considered unacceptable).

Particle size: A particle sizer was used to calculate the surface and volume diameter of particles. An Eyetech particle sizer was used to measure the D3.2 and D4.3 values. D3.2 is the surface weighted average diameter, whereas D4.3 is the volume mean diameter. The mean and median particle sizes were measured using a Horiba LA-960 particle sizer. The graph is plotted with diameter in microns on the x-axis, and the y-axis is q %, which is the % in a given histogram channel.

The particle size results for each of Formulas A to D are shown in Table 2 below. Three samples for each formula were evaluated and the averages are presented in the table.

TABLE 2

| | |
|---|---|
| Particle Size | Particle Size |
| Before Shaking | After Shaking |

| | D3.2 | D4.3 | D3.2 | D4.3 |
|---|---|---|---|---|
| Sample | (μm) | (μm) | (μm) | (μm) |
| Formula A | 18.45 | 24.94 | 18.69 | 25.34 |
| Formula B | 20.18 | 30.37 | 19.53 | 27.87 |
| Formula C | 21.01 | 32.31 | 21.32 | 31.59 |
| Formula D | 26.45 | 37.90 | 27.90 | 40.34 |

In all samples, particle size was found to be similar before and after shaking. Overall, Formula C with faba protein was deemed to be the best performing, though Formulas A and B with faba protein were also considered acceptable. Formula D with chickpea protein was considered unacceptable, primarily due to oil separation and coalescence of the fat globules. Accordingly, it was found that a combination of flaxseed fiber and faba bean protein were important for providing desired stability properties in the final product at 70% oil content. Chickpea protein was considered an ineffective substitute for faba bean protein in the mayonnaise-type food products.

### Example 2

To evaluate emulsion stability and rheology of different mayonnaise-type formulations, mayonnaise-type products were prepared according to the formulations of Table 3. The mayonnaise-type products were prepared using the method described in Example 1.

TABLE 3

| | Formula E: | Formula F: | Formula G: | Formula H: |
|---|---|---|---|---|
| | Faba + | Higher | Higher | Faba + |
| | citrus fiber | faba, | faba + | citrus fiber |
| | (higher oil) | no fiber | citrus fiber | (lower oil) |
| | (wt. %) | (wt. %) | (wt. %) | (wt. %) |
| Water | 19.37 | 24.2 | 24.2 | 24.37 |
| Sugar | 1.5 | 1.5 | 1.5 | 1.5 |
| Salt | 1.0 | 1.0 | 1.0 | 1.0 |
| Vinegar | 1.0 | 2.0 | 2.0 | 1.0 |
| (19.5%) | | | | |
| Lemon juice | 0.83 | — | — | 0.83 |
| Citrus fiber | 0.5 | — | 1 | 0.5 |
| (ConCel CF 05 | | | | |
| from Condio) | | | | |
| Faba bean | 0.8 | 1 | 1 | 0.8 |
| protein | | | | |
| (Vitessence | | | | |
| 3600 from | | | | |
| Ingredion) | | | | |
| Rapeseed oil | 75 | 70 | 70 | 70 |
| Starch | — | 1 | — | — |
| (Lumina 340) | | | | |
| | 100 | 100 | 100 | 100 |

The samples were analyzed about one week after storage at 20° C. The samples were then evaluated as described in Example 1 before and after shaking for 2 hours at 300 rpm.

Visual Observation: Samples were visually observed for appearance and oil separation after shaking.

The samples made with citrus fiber (Formulas E, G, and H) had a lumpy appearance and were more opaque than samples made with flaxseed fiber. Therefore, the inclusion of citrus fiber was found to be undesirable at least from a product appearance standpoint.

For Formulas E (Faba+citrus fiber) and F (Faba, no fiber), slight phase separation was observed in both formulas before shaking. After shaking, oil separation was observed along the sides of the jar in both samples, indicating unacceptable emulsion stability.

Before shaking, no oil separation was observed in formulas G (higher faba+citrus fiber) and H (Faba+citrus fiber, lower oil). After shaking, oil separation was observed along the sides of the jar for both formulas. Accordingly, formulas G and H also had unacceptable emulsion stability.

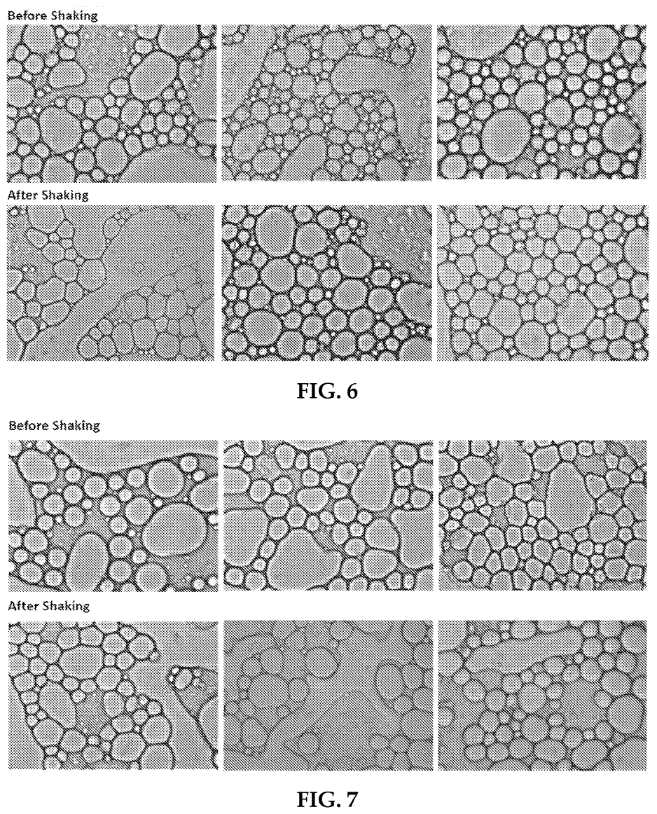

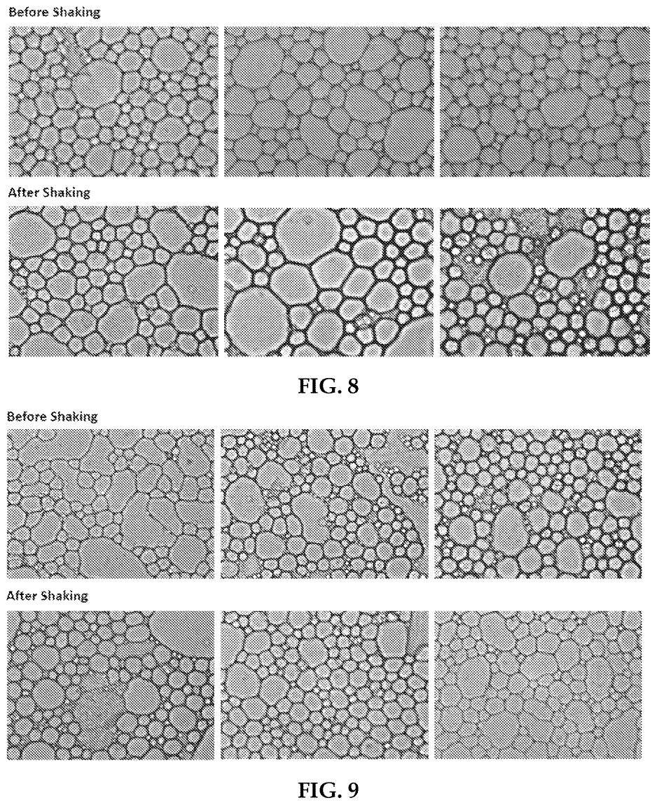

Microscopy: A light microscope (magnification: 40×) was used to observe the samples before and after shaking to look for coalescence and globule size of oil droplets.
Formula E is shown in FIG. 6, Formula F is shown in FIG. 7, Formula G is shown in FIG. 8, and Formula H is shown in FIG. 9. The following observations were made:
Formula E (Faba+citrus fiber): Coalescence was observed before and after shaking (considered unacceptable).
Formula F (Higher faba, no fiber): Coalescence was observed before and after shaking (considered unacceptable).
Formula G (Higher faba+citrus fiber): Large oil globules were observed before shaking (considered unacceptable). Coalescence was observed after shaking (considered unacceptable).
Formula H (Faba+citrus fiber, lower oil): Coalescence was observed before and after shaking (considered unacceptable).

Because Formulas E, F, and H showed coalescence and Formula G showed large oil globules before shaking, all samples were considered unacceptable even before shaking. After shaking, all samples showed coalescence.

Particle size: The particle size results for each of Formulas E to H are shown in Table 4 below. Three samples for each formula were evaluated and the averages are presented in the table.

TABLE 4

| | |
|---|---|
| Particle Size | Particle Size |
| Before Shaking | After Shaking |

| | D3.2 | D4.3 | D3.2 | D4.3 |
|---|---|---|---|---|
| Sample | (μm) | (μm) | (μm) | (μm) |
| Formula E | 40.98 | 57.47 | 40.57 | 54.37 |
| Formula F | 38.78 | 48.91 | 37.56 | 47.96 |
| Formula G | 41.39 | 54.34 | 37.15 | 47.37 |
| Formula H | 35.84 | 46.45 | 35.07 | 46.59 |

All samples showed a relatively large particle size before and after shaking. Formulas E, G, and H showed large standard deviation within the same batch, which may have been a result of the citrus fiber content.

Rheology: These samples were further evaluated for storage modulus. The shear rate ramp test determines the influence of viscosity with a logarithmic increase of shear rate. A Kinexus rheometer was used to measure the amplitude sweep of the samples using a cone-plate geometry (CP4/40 SC0095 SS). Measurements are performed at 25 C. The storage modulus is measured over a range of shear strain from 0.1% to 100% at a set frequency of 1 Hz. The main aim of the amplitude sweep test was to measure the Linear Visco-Elastic region (LVER) of the sample and to analyze its robustness. Since G′ (elastic modulus) is a measure of structural integrity, any drop in G′ indicates a breakdown of material structure and hence the onset of non-linearity. The G′ (Pa) values are presented in Table 9 below.

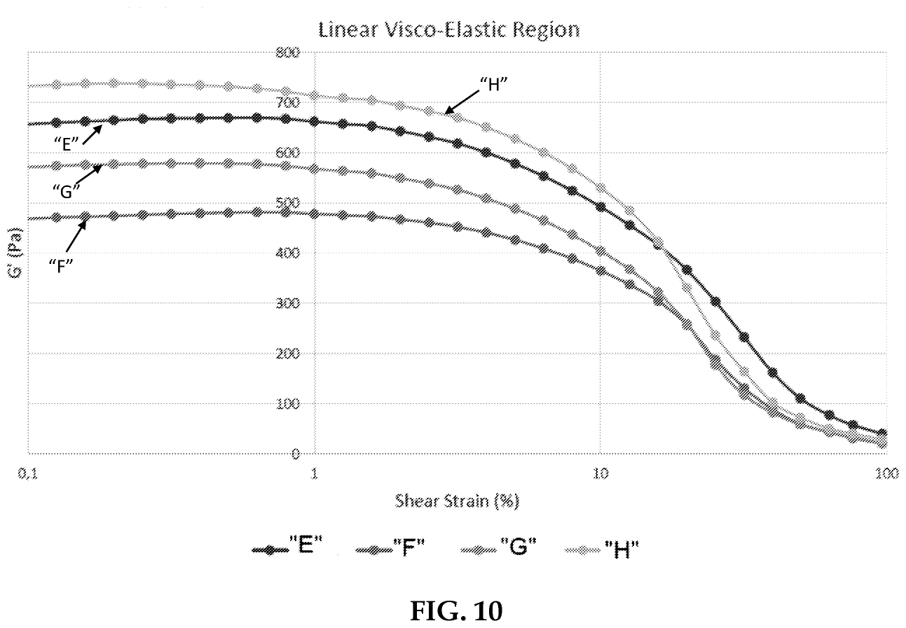

The rheology results are shown in FIG. 10 and in Table 5 below:

TABLE 5

| Samples | Storage Modulus (Pa) |
|---|---|
| Formula E | 662.22 |
| Formula F | 474.53 |
| Formula G | 574.85 |
| Formula H | 733.57 |

Formulas E and H showed the highest storage modulus (structural integrity) whereas Formula F showed the lowest storage modulus. Formulas E and F showed the longest linear visco-elastic region (LVER) whereas Formula H showed the smallest LVER (quick drop in visco-elasticity with higher shear strain). However, all of the storage modulus values were low overall, indicating that the samples do not hold their structure. A desirable storage modulus value for a mayonnaise-type product is generally at least 1000 Pa, and generally in the range of about 1000 Pa to about 2000 Pa.

Overall, all samples were found to be unacceptable, indicating that citrus fiber is an unacceptable substitute for flaxseed fiber at different oil and protein levels, and that the sample without fiber lacked emulsion stability.

### Example 3

To evaluate emulsion stability, a mayonnaise-type product was prepared and evaluated that included a combination of faba protein, flaxseed fiber, and starch. The mayonnaise product was prepared according to the formulation of Table 6. The mayonnaise-type products were prepared using the method described in Example 1.

TABLE 6

| | Formula I: |
|---|---|
| | Faba + Fiber + |
| | Starch |
| | (wt. %) |
| Sugar | 1.5 |
| Salt | 1.0 |
| Mustard | 2.35 |
| Spirit vinegar (19.5%) | 1.7 |
| Lemon juice concentrate | 0.6 |
| (45 Brix) | |
| Flaxseed fiber (Hi- | 0.8 |
| Smooth from Hi-Food) | |
| Faba bean protein | 0.6 |
| (Vitessence 3600 | |
| from Ingredion) | |
| Functional native starch | 1.2 |
| (Starch Novation ® | |
| 4300 (Ingredion)) * | |
| Water | 30.25 |
| Rapeseed oil | 60.0 |
| | 100.0 |

* Starch Novation ® 4300 is a cold water-swelling (CWS) waxy corn starch.

The samples were analyzed about one week after storage at 20° C. The finished product was evaluated for emulsion stability and found to be suitably stable during the product shelf life. The product was stored at 4° C., 20° C., and 30° C. for up to 9 months. The product gave acceptable sensory results (flavor, color, odor) and emulsion stability (appearance) for 9 months when stored at 4° C. and 20° C. The product stored at 30° C. began to give less favorable sensory results only at month 4.

### Example 4

Additional exemplary mayonnaise formulations were prepared according to the three formulations in Table 7 below. The mayonnaise-type products were prepared using the method described in Example 1.

TABLE 7

| | Formula J: | | |
|---|---|---|---|
| | Faba, flax, | Formula K: | Formula L: |
| | starch, | Faba, flax, | Faba, flax, |
| | low oil | higher oil | higher oil |
| | (wt. %) | (wt. %) | (wt. %) |
| Sugar | 1.5 | 1.5 | 1.5 |
| Salt | 1 | 1 | 1 |
| Mustard | 2.4 | — | — |
| Spirit vinegar (14%) | 1.4 | 1.4 | 1.4 |
| Lemon juice | 0.5 | 0.8 | 0.6 |
| concentrate | | | |
| Flaxseed fiber | 0.7 | 0.8 | 0.8 |
| (Hi-Smooth | | | |
| from Hi-Food) | | | |
| Faba bean protein | 0.5 | 0.6 | 0.5 |
| (Vitessence 3600 | | | |
| from Ingredion) | | | |
| Functional native | 1.3 | — | — |
| starch (Starch | | | |
| Novation ® 4300 | | | |
| (Ingredion) | | | |
| Water | 30.7 | 22 | 24.8 |
| Sunflower oil | 60 | 68 | 68 |
| Flavor (garlic, | — | 3.9 | 1.4 |
| spices, pepper) | | | |
| | 100.0 | 100.0 | 100.0 |

Formula J included a viscosity-building amount of starch. The product of Formula J was also evaluated for emulsion stability and found to be suitably stable during the product shelf life. The product was stored at 4° C., 20° C., and 30° C. for up to 9 months. The product gave acceptable sensory results (flavor, color, odor) and emulsion stability (appearance) for 9 months when stored at 4° C. and 20° C. The product stored at 30° C. began to give less favorable sensory results only at month 4.

The viscosity of Formula J was also measured over a period of 12 months. Viscosity was measured with a Brookfield viscometer, equipment HA, spindle 6, speed 12 rpm, for 30 seconds at 4° C., 20° C., and 30° C. Two measurements were taken, and the average is presented in Table 8 below.

TABLE 8

| | | Average viscosity |
|---|---|---|
| | | (cP) |
| 2 months | 4° C. | 46,665 |
| | 20° C. | 47,250 |
| | 30° C. | 45,165 |
| 3 months | 4° C. | 44,268 |
| | 20° C. | 45,213 |
| | 30° C. | 39,847.5 |
| 4 months | 4° C. | 51,335 |
| | 20° C. | 40,585 |
| | 30° C. | 46,500 |
| 6 months | 4° C. | 48,665 |
| | 20° C. | 38,415 |
| 9 months | 4° C. | 51,585 |
| | 20° C. | 42,415 |
| 12 months | 4° C. | 49,430 |
| | 20° C. | 43,345 |

Though similar tests were not completed for Formulas K and L, they are expected to have similar emulsion stability during storage.

### Example 5

Further mayonnaise-type products were prepared to evaluate the use of different thickeners and emulsifiers on the particle size and rheology characteristics of the finished products. The products were also compared to a mayonnaise product including an egg-based emulsifier rather than a plant-based protein. Products were prepared according to the formulations in Table 9 below. The mayonnaise-type products were prepared using the method described in Example 1.

TABLE 9

| | Formula M: | Formula N: | Formula O: | Formula P: |
|---|---|---|---|---|
| | Faba, flax, | No | Citrus | Egg-based |
| | starch | flax | fiber | mayonnaise |
| | (wt. %) | (wt. %) | (wt. %) | (wt. %) |
| Water | 31.05 | 31.85 | 31.05 | 19.92 |
| Lemon juice | 0.5 | 0.5 | 0.5 | — |
| concentrate | | | | |
| Vinegar | 1 | 1 | 1 | 2.28 |
| (19.5%) | | | | |
| Sugar | 1.5 | 1..5 | 1.5 | 1.5 |
| Salt | 1 | 1 | 1 | 0.38 |
| Flaxseed | 0.8 | — | — | — |
| fiber | | | | |
| (Hi Smooth) | | | | |
| Mustard | 2.35 | 2.35 | 2.35 | 0.5 |
| Faba bean | 0.6 | 0.6 | 0.6 | — |
| protein | | | | |
| (Vitessence | | | | |
| 3600 from | | | | |
| Ingredion) | | | | |
| EDTA | — | — | — | 0.01 |
| Egg yolk | — | — | — | 5.63 |
| (salted) | | | | |
| Rapeseed oil | 60 | 60 | 60 | 68.33 |
| Starch | 1.2 | 1.2 | 1.2 | 1 |
| Novation | | | | |
| 4300 starch | | | | |
| Citrus fiber | — | — | 0.8 | — |
| Nutrava | | | | |
| (CP Kelco) | | | | |
| Starch mix | — | — | — | 1.46 |
| (corn and | | | | |
| tapioca corn | | | | |
| water swelling | | | | |
| starches) | | | | |
| | 100 | 100 | 100 | 100 |

The samples were analyzed about one week after storage at 20° C. The samples were evaluated as described in Examples 1 and 2.

Microscopy Observation: A light microscope (magnification: 40×) was used to observe the samples before and after shaking to look for coalescence and globule size of oil droplets.
Formula M (Faba, flax, starch): Large oil globules were observed.
Formula N (No flax): Coalescence of the oil droplets was observed (considered unacceptable).
Formula O (Citrus fiber): Large oil globules were observed.

Particle size: Measurements were performed using a Horiba LA-960 particle sizer. The graph is plotted with diameter in microns on the x-axis, and the y-axis is q %, which is the % in a given histogram channel. Mean Size depicts the volume mean diameter, also known as the D(4.3). Median Size is the value where half of the population resides above this point, and half resides below this point (i.e., D50).

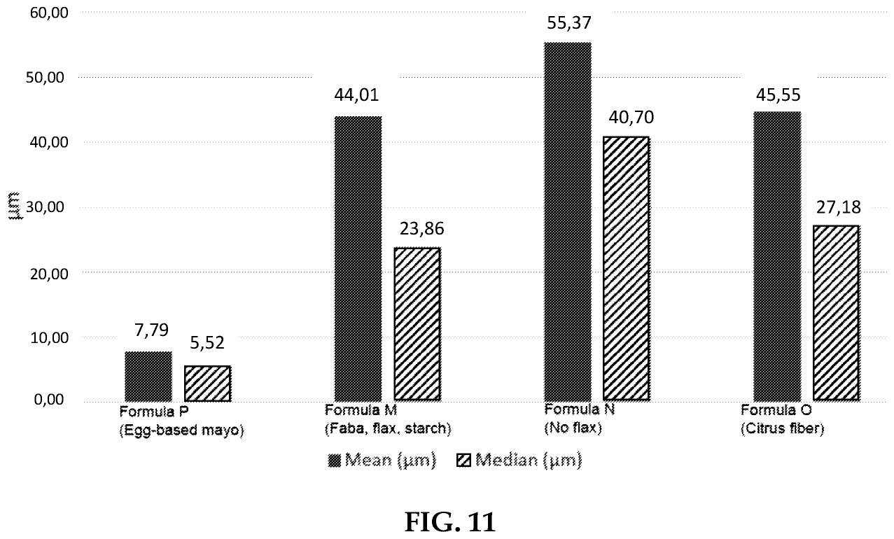

The particle size results (mean and median) are presented in FIG. 11. The egg-based mayonnaise product (formula P) showed a lower particle size compared to the plant-based formulas M (flax, fiber, starch) and O (citrus fiber). The sample without flax (Formula N) showed higher particle size due to coalescence (emulsion instability). Formulas M and O were similar in particle size but citrus fiber provided an undesirable lumpy texture to the product.

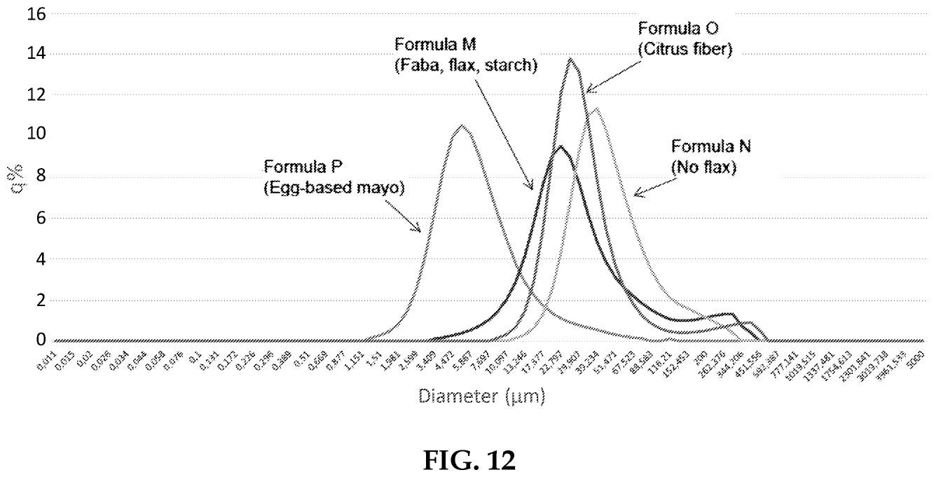

The particle size distribution data is presented in FIG. 12. The egg-based mayonnaise product (formula P) showed a monomodal distribution and the smallest particle sizes, whereas plant-based formulas M (flax, fiber, starch) and O (citrus fiber) showed a bimodal distribution. The sample without flax (formula N) showed a larger particle size due to coalescence. Whether the samples showed a monomodal or bimodal distribution does not necessarily reflect the stability of the product but more so the other ingredients in the product.

Rheology: Rheology was analyzed as described in Example 2. The G′ (Pa) values are presented in Table 10 below.

TABLE 10

| | Storage Modulus, |
|---|---|
| Sample | G′ (Pa) |
| Formula P (egg-based) | 432.44 |
| Formula M (faba, flax, starch) | 1568.61 |
| Formula N (no flax) | 274.4 |
| Formula O (citrus fiber) | 1546.33 |

The formula M sample (faba, flax, starch) and Formula O (citrus fiber) showed a similar linear visco-elastic region and storage modulus, which was significantly higher than Formula P (egg-based mayo). The Formula N sample (no flax) showed the lowest storage modulus due to coalescence.

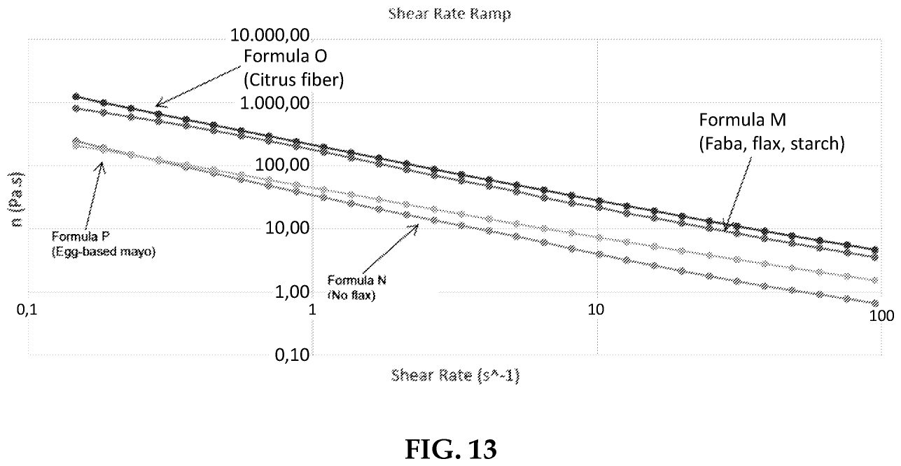

The results of the amplitude sweep test are presented in FIG. 13. Formula O (citrus fiber) showed the highest viscosity over the shear rate ramp profile followed by formula M (faba, flax, starch). Formula P (egg-based mayo) and Formula N (no flax) showed a similar shear rate ramp profile. At a higher shear rate, Formula N showed a rapid decline in viscosity due to coalescence.

Yield stress is measured by determining the stress at which the viscosity peak is observed. Prior to the viscosity peak, the material is undergoing elastic deformation where the sample stretches and the peak in viscosity represents the point at which the elastic structure breaks down (yields) and the material starts to flow.

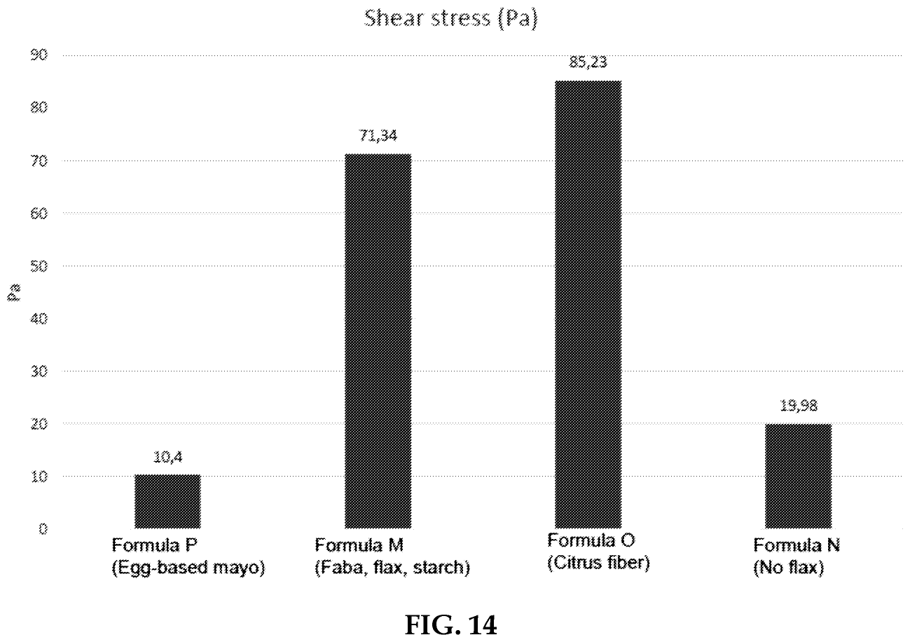

The yield stress data is presented in FIG. 14. Formula O (citrus fiber) showed the highest yield stress followed by formula M (faba, flax, starch). In comparison, the Formula P (egg-based mayo) and Formula N (no flax) showed lower yield stress.

Overall, Formula M and O had suitable storage modulus values, but the citrus fiber in Formula O contributed to an undesirable lumpy texture to the product.

### Example 6

Mayonnaise-type products were prepared with and without starch to evaluation the impact of starch on emulsion stability of the finished product at 60% oil content. Products were prepared according to the formulations in Table 11 below. The mayonnaise-type products were prepared using the method described in Example 1.

TABLE 11

| | Formula Q: | Formula R: |
|---|---|---|
| | Starch | No Starch |
| | (wt. %) | (wt. %) |
| Water | 30.35 | 32.25 |
| Lemon juice | 0.5 | 0.5 |
| concentrate | | |
| Vinegar (19.5%) | 1.7 | 1.0 |
| Sugar | 1.5 | 1.5 |
| Salt | 1.0 | 1.0 |
| Flaxseed fiber | 0.8 | 0.8 |
| (Hi Smooth) | | |
| Mustard | 2.35 | 2.35 |
| Faba bean protein | 0.6 | 0.6 |
| (Vitessence 3600 | | |
| from Ingredion) | | |
| Rapeseed oil | 60 | 60 |
| Starch (Starch Novation ® | 1.2 | — |
| 4300 (Ingredion)) | | |
| | 100 | 100 |

The samples were analyzed about one week after storage at 20° C. The analytical techniques described above in Examples 1 and 2 were used to evaluate the samples.

Visual Observation: Upon visual inspection of Formula R before shaking, no oil separation was observed. After shaking, visible oil separation was observed. There was no oil separation in Formula Q before or after shaking.

Microscopy: A light microscope (magnification: 40×) was used to observe coalescence and globule size of oil droplets in samples before and after shaking. Coalescence and large globule size are indicative of an unstable emulsion that is unsuitable for use as a mayonnaise-type product.

When observed under the microscope before and after shaking, Formula R (no starch) had a large globule size that was considered unacceptable. Formula Q showed large globules with no change before and after shaking.

Particle Size: A Horiba LA-960 particle sizer was used to plot a graph of diameter in microns on the x-axis and q % on the y-axis, which is the % in a given histogram channel. Mean size depicts the volume mean diameter, also known as the D(4,3). Median size is the value where half of the population resides above this point, also known as D50.

The particle size results are shown in Table 12 below. Three measurements were taken and the average is presented in the table below.

TABLE 12

| | |
|---|---|
| Particle Size | Particle Size |
| Before Shaking | After Shaking |

| | D3.2 | D4.3 | D3.2 | D4.3 |
|---|---|---|---|---|
| | (μm) | (μm) | (μm) | (μm) |
| Formula Q | 23.02 | 30.59 | 25.61 | 35.50 |
| Formula R | 25.76 | 37.56 | 29.39 | 42.06 |
| (no starch) | | | | |

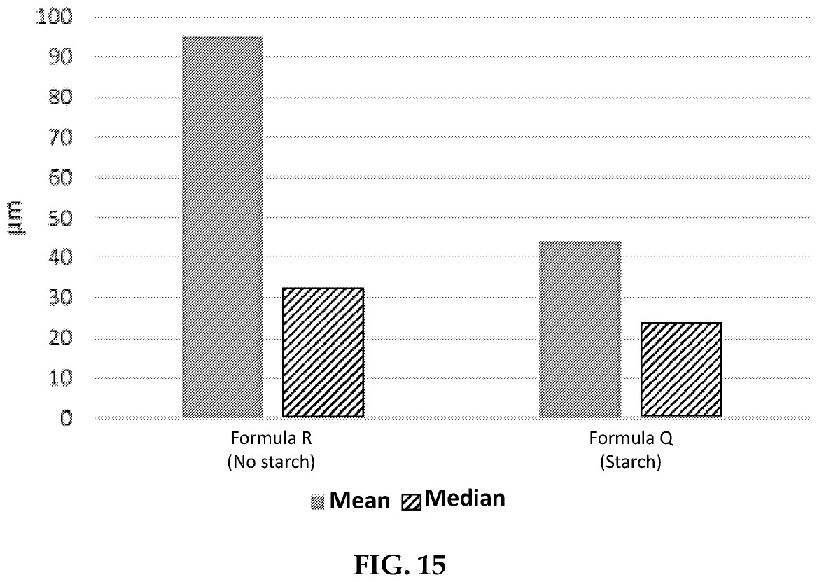

The particle size results (mean and median) are also presented in FIG. 15. Formula R (no starch) showed a higher particle size than Formula Q (starch).

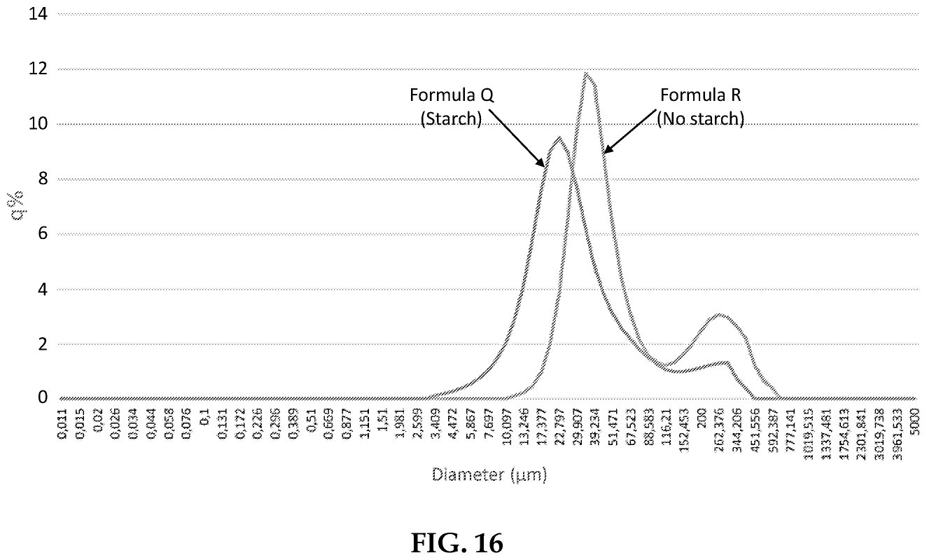

The particle size distribution data is presented in FIG. 16. Both Formula Q (starch) and Formula R (no starch) showed a bimodal particle size distribution. The sample without starch (Formula R) showed a larger particle size.

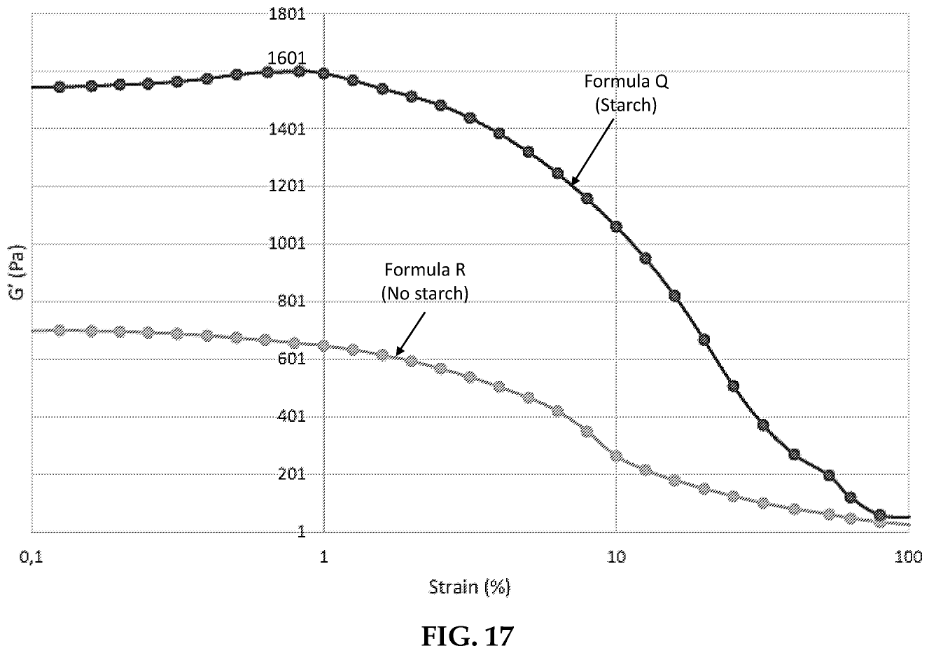

Rheology: The rheology data is presented in FIG. 17 and in Table 13 below. Formula Q (starch) showed a higher storage modulus and longer visco-elastic region compared to Formula R (no starch).

Viscosity was measured using a Brookfield viscometer HA (spindle 5) at 30 rpm for 30 seconds at 20° C. Two measurements were taken for each formula and the averages are presented in Table 13.

TABLE 13

| | Storage | Viscosity |
|---|---|---|
| Sample | Modulus, G′ (Pa) | (cP) |
| Formula Q (starch) | 1568.61 | 40,000 |
| Formula R (no starch) | 696.08 | 7106.5 |

Overall, the data on Formula R (no starch) compared to Formula Q (starch) indicated that not adding starch resulted in visible oil separation after shaking, an increase in particle size, and a decrease in storage modulus for a product with 60% oil. Thus, Formula R (no starch) was found to be unacceptable at 60% oil.

### Example 7

Additional mayonnaise-type products were prepared to evaluate the use of different amounts of oil and different plant proteins on emulsion stability of the finished products. Low oil content products (15% oil) were prepared according to the formulations in Table 14 below, and high oil content products (80% oil) were prepared according to the formulations in Table 15 below. The mayonnaise-type products were prepared using the method described in Example 1.

TABLE 14

| | Formula S: | Formula T: | Formula U: | Formula V: | Formula W: |
|---|---|---|---|---|---|
| | Faba, | Chickpea, | Pea, | Potato 300*, | Potato 200* |
| | Low Oil | Low Oil | Low Oil | Low Oil | Low Oil |
| | (wt. %) | (wt. %) | (wt. %) | (wt. %) | (wt. %) |
| Water | 77.25 | 77.25 | 77.25 | 77.25 | 77.25 |
| Lemon juice | 0.5 | 0.5 | 0.5 | 0.5 | 0.5 |
| concentrate | | | | | |
| Vinegar | 1.0 | 1.0 | 1.0 | 1.0 | 1.0 |
| (19.5%) | | | | | |
| Sugar | 1.5 | 1.5 | 1.5 | 1.5 | 1.5 |
| Salt | 1.0 | 1.0 | 1.0 | 1.0 | 1.0 |
| Flaxseed | 0.8 | 0.8 | 0.8 | 0.8 | 0.8 |
| fiber | | | | | |
| (HiSmooth) | | | | | |
| Mustard | 2.35 | 2.35 | 2.35 | 2.35 | 2.35 |
| Faba bean | 0.6 | — | — | — | |
| protein | | | | | |
| (Vitessence | | | | | |
| 3600 from | | | | | |
| Ingredion) | | | | | |
| Chickpea | — | 0.6 | — | — | — |
| protein | | | | | |
| (ChickP) | | | | | |
| Pea protein | — | — | 0.6 | — | — |
| (Vitessence | | | | | |
| Pulse 1550 | | | | | |
| from | | | | | |
| Ingredion) | | | | | |
| Potato | — | — | — | 0.6 | — |
| protein | | | | | |
| (Solanic 300) | | | | | |
| Potato | — | — | — | — | 0.6 |
| protein | | | | | |
| (Solanic 200) | | | | | |
| Rapeseed oil | 15 | 15 | 15 | 15 | 15 |
| | 100 | 100 | 100 | 100 | 100 |

*“Potato 300” (Solanic ® 300) and “Potato 200” (Solanic ® 200) are potato protein products from Avebe having different isoelectric points. Potato 300 may be more suitable for use in a low pH product due to its higher isoelectric point, whereas Potato 200 may be more suitable for use in a higher pH product.

TABLE 15

| | Formula X: | Formula Y: | Formula Z: | Formula AA: | Formula BB: |
|---|---|---|---|---|---|
| | Faba, High | Chickpea, | Pea, High | Potato 300, | Potato 200, |
| | Oil | High Oil | Oil | High Oil | High Oil |
| | (wt. %) | (wt. %) | (wt. %) | (wt. %) | (wt. %) |
| Water | 12.25 | 12.25 | 12.25 | 12.25 | 12.25 |
| Lemon juice | 0.5 | 0.5 | 0.5 | 0.5 | 0.5 |
| concentrate | | | | | |
| Vinegar | 1.0 | 1.0 | 1.0 | 1.0 | 1.0 |
| (19.5%) | | | | | |
| Sugar | 1.5 | 1.5 | 1.5 | 1.5 | 1.5 |
| Salt | 1.0 | 1.0 | 1.0 | 1.0 | 1.0 |
| Flaxseed | 0.8 | 0.8 | 0.8 | 0.8 | 0.8 |
| fiber (Hi | | | | | |
| Smooth) | | | | | |
| Mustard | 2.35 | 2.35 | 2.35 | 2.35 | 2.35 |
| Faba bean | 0.6 | — | — | — | |
| protein | | | | | |
| Chickpea | — | 0.6 | — | — | — |
| protein | | | | | |
| Pea protein | — | — | 0.6 | — | — |
| Potato | — | — | — | 0.6 | — |
| protein | | | | | |
| (Solanic 300) | | | | | |
| Potato | — | — | — | — | 0.6 |
| protein | | | | | |
| (Solanic 200) | | | | | |
| Rapeseed oil | 80 | 80 | 80 | 80 | 80 |
| | 100 | 100 | 100 | 100 | 100 |

The samples were analyzed about one week after storage at 20° C. The same analytical techniques described above in Examples 1 and 2 were used to evaluate samples of these low and high oil formulations.

Visual Observation: Results from the visual inspection of Formula X, Formula Y, and Formula Z before and after shaking are summarized below:
Formula S (faba, low oil): Split emulsion.
Formula T (chickpea, low oil): Split emulsion.
Formula U (pea, low oil): Split emulsion.
Formula V (potato 300, low oil): Split emulsion.
Formula W (potato 200, low oil): Split emulsion.
Formula X (faba, high oil): Before and after shaking, no oil separation was observed.
Formula Y (chickpea, high oil): Before shaking, no oil separation was observed. After shaking, visible oil separation was observed.
Formula Z (pea, high oil): Before and after shaking, no oil separation was observed.
Formula AA (potato 300, high oil): Split emulsion.
Formula BB (potato 200, low oil): Split emulsion.

Microscopy: Results from inspection of Formula X (faba, high oil), Formula Y (chickpea, high oil), and Formula Z (pea, high oil) under the microscope before and after shaking are summarized below:
Formula X (faba, high oil): Large globule size observed before and after shaking, but globule size remained the same.
Formula Y (chickpea, high oil): Coalescence observed before and after shaking (considered unacceptable).
Formula Z (pea, high oil): Large globule size observed before and after shaking, but globule size remained the same.

While Formulas X and Z had high globule size before and after shaking, no coalescence was observed and the oil globules were of similar size before and after shaking. Therefore, Formulas X (faba) and Z (pea) performed better than Formula Y (chickpea).

Particle Size: The particle size (mean) results for Formula X (faba, high oil), Formula Y (chickpea, high oil), and Formula Z (pea, high oil) are shown in Table 16. Samples were evaluated in triplicate and the averages are shown below.

TABLE 16

| | Particle Size Before Shaking | | Particle Size After Shaking | |
|---|---|---|---|---|
| | D3, 2 | D4, 3 | D3, 2 | D4, 3 |
| | (μm) | (μm) | (μm) | (μm) |
| Formula X | 31.78 | 45.40 | 29.53 | 41.28 |
| (Faba, High | | | | |
| Oil) | | | | |
| Formula Y | 40.42 | 53.73 | 38.16 | 48.54 |
| (Chickpea, | | | | |
| High Oil) | | | | |
| Formula Z | 32.38 | 48.35 | 32.29 | 52.60 |
| (Pea, High | | | | |
| Oil) | | | | |

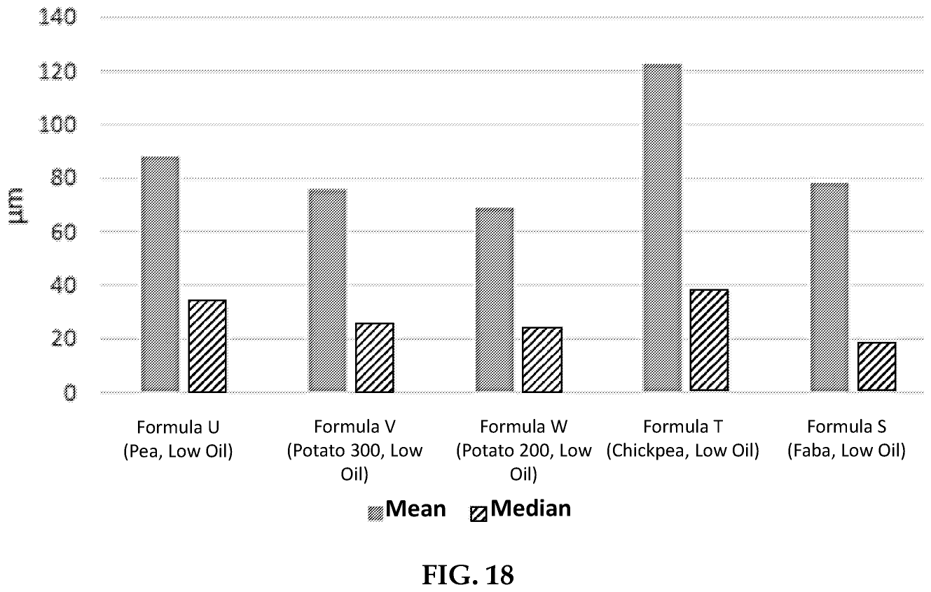

The particle size results (mean and median) for the low oil formulations are presented in FIG. 18. All low oil samples had a split emulsion, and Formula T (chickpea, low oil) showed the highest particle size.

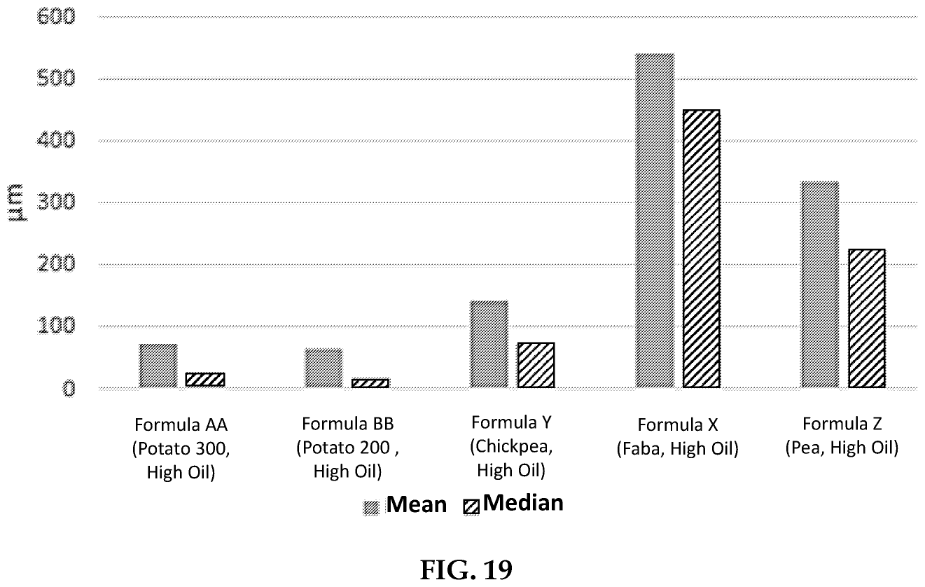

The particle size results (mean and median) for the high oil formulations in Table 12 are presented in FIG. 19. Though Formula X (faba, high oil) showed the highest particle size, followed by Formula Z (pea, high oil), those samples did not have oil separation during the shaking test. Therefore, despite the larger oil droplet sizes, the samples were acceptable.

Formula BB (potato 200, high oil) had a split emulsion.

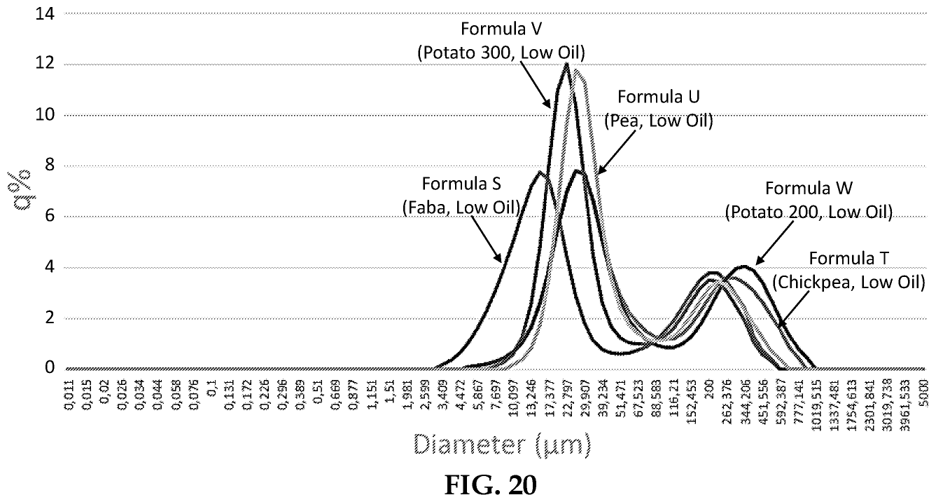

The particle size distribution data for the low oil formulations is presented in FIG. 20. All low oil formulations exhibited a split emulsion. Further, all low oil formulations showed a bimodal particle size distribution.

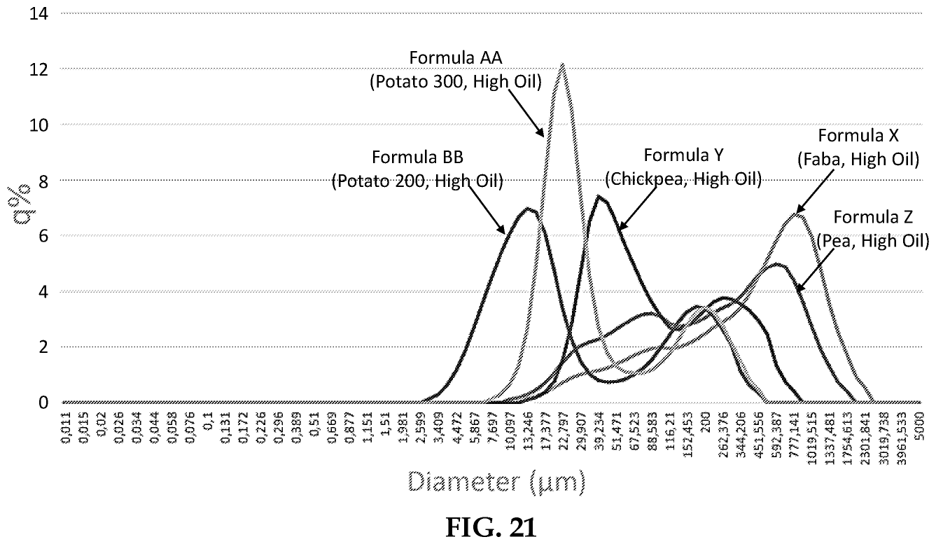

The particle size distribution data for the high oil formulations is presented in FIG. 21. Formula BB (potato 200, high oil) exhibited a split emulsion. All high oil samples showed a bimodal particle size distribution.

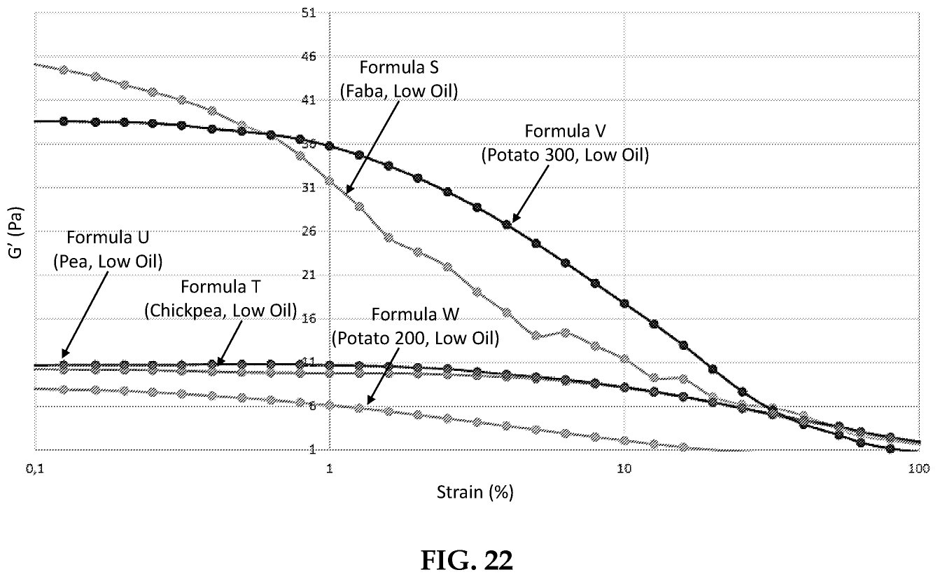

The rheology data for the low oil formulations in Table 11 is presented in FIG. 22. All low oil samples showed a significantly lower storage modulus, for example, than the sample of Formula Q (starch), which was prepared with 60% oil. Further, all low oil samples had a split emulsion.

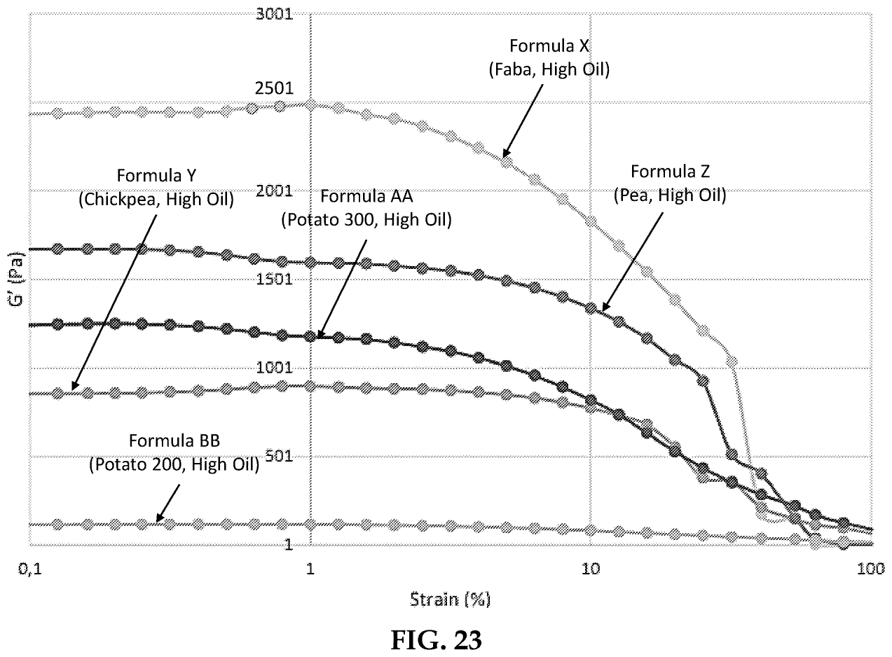

Rheology: The rheology data for the high oil formulations is presented in FIG. 23 and Table 17 below. Formula BB (potato 200, high oil) had a significantly lower storage modulus than the other high oil formulations. Formula BB (potato 200, high oil) also had a split emulsion. Formula X (faba, high oil) showed the highest storage modulus among the high oil formulations. Formula Y (chickpea, high oil) showed the longest visco-elastic region (LVER) but had a relatively low storage modulus, whereas Formula AA (potato 300, high oil) and Formula Z (pea, high oil) showed the lowest LVER but had higher storage modulus values.

Viscosity was measured using a Brookfield viscometer HA (spindle 5) at 30 rpm for 30 seconds at 20° C. Two measurements were taken for each formula and the averages are presented in Table 17.

TABLE 17

| | Storage Modulus, | Viscosity |
|---|---|---|
| Sample | G′ (Pa) | (cP) |
| Formula X (faba, high oil) | 2451.3 | Over the device |
| | | measurement limit |
| | | of 26,670 |
| Formula Y (chickpea, high | 872.12 | 21,840 |
| oil) | | |
| Formula Z (pea, high oil) | 1670 | Over the device |
| | | measurement limit |
| | | of 26,670 |
| Formula AA (potato 300, | 1244.4 | 1880 |
| high oil) | | |
| Formula BB (Potato 200, | N/A* | 625.5 |
| high Oil) | | |

*Because no emulsion was formed, G′ could not be measured.

Overall, based on the data from the low oil formulations, the lower oil content resulted in oil and/or phase separation in all samples and a lower storage modulus. All low oil samples had a split emulsion so were found to be unacceptable.

In the high oil formulations, potato 200 protein (Formula BB) resulted in a split emulsion. Formulas Y (chickpea, high oil) and Z (pea, high oil), which showed coalescence, were also found to be unacceptable. Formula AA (potato 300, high oil) and Formula Z (pea, high oil) showed lower visco-elasticity and a smaller particle size. Formula X (faba, high oil) showed the highest storage modulus and a larger particle size.

### Example 8

Mayonnaise-type products were also prepared to evaluate the use of different plant proteins on emulsion stability of the finished products. Products were prepared according to the formulations in Table 18 below. Each of the formulations in Table 18 includes 70% oil and no starch. The mayonnaise-type products were prepared using the method described in Example 1.

TABLE 18

| | Formula CC: | Formula DD: | Formula EE: | Formula FF: | Formula GG: |
|---|---|---|---|---|---|
| | Potato 300 | Potato 200 | Chickpea | Faba | Pea |
| | (wt. %) | (wt. %) | (wt. %) | (wt. %) | (wt. %) |
| Water | 21.65 | 21.65 | 21.65 | 21.65 | 21.65 |
| Lemon juice | 0.5 | 0.5 | 0.5 | 0.5 | 0.5 |
| concentrate | | | | | |
| Vinegar | 1.7 | 1.7 | 1.7 | 1.7 | 1.7 |
| (19.5%) | | | | | |
| Sugar | 1.5 | 1.5 | 1.5 | 1.5 | 1.5 |
| Salt | 1.0 | 1.0 | 1.0 | 1.0 | 1.0 |
| Flaxseed | 0.8 | 0.8 | 0.8 | 0.8 | 0.8 |
| fiber (Hi | | | | | |
| Smooth) | | | | | |
| Mustard | 2.35 | 2.35 | 2.35 | 2.35 | 2.35 |
| Faba bean | — | — | — | 0.5 | — |
| protein | | | | | |
| Chickpea | — | — | 0.5 | — | — |
| protein | | | | | |
| Potato | 0.5 | — | — | — | — |
| protein | | | | | |
| (Solanic 300) | | | | | |
| Potato | — | 0.5 | — | — | — |
| protein | | | | | |
| (Solanic 200) | | | | | |
| Pea protein | — | — | — | — | 0.5 |
| (Prista 155) | | | | | |
| Rapeseed oil | 70 | 70 | 70 | 70 | 70 |
| | 100 | 100 | 100 | 100 | 100 |

The same analytical techniques described above in Examples 1 and 2 were used to evaluate the formulations in Table 18.

Visual Observation: Results from the visual inspection of the formulations in Table 18 before and after shaking are summarized below:
Formula CC (potato 300): Before and after shaking, no oil separation was observed.
Formula DD (potato 200): Before and after shaking, no oil separation was observed.
Formula EE (chickpea): Before and after shaking, no oil separation was observed.
Formula FF (faba): Before and after shaking, no oil separation was observed.
Formula GG (pea): Before and after shaking, no oil separation was observed.

Microscopy: Results from inspection of the formulations in Table 18 under the microscope before and after shaking are summarized below:
Formula CC (potato 300): Coalescence observed before and after shaking (considered unacceptable).
Formula DD (potato 200): Coalescence observed before and after shaking (considered unacceptable).
Formula EE (chickpea): Coalescence observed before and after shaking (considered unacceptable).
Formula FF (faba): Large globule size observed before and after shaking, but the globule size remained the same (acceptable).
Formula GG (pea): Large globule size observed before and after shaking, but the globule size remained the same (acceptable).

Particle Size: The particle size results for Formula CC (potato 300), Formula DD (potato 200), Formula EE (chickpea), Formula FF (faba), and Formula GG (pea) are shown in Table 19 below.

TABLE 19

| | Particle Size Before Shaking | | Particle Size After Shaking | |
|---|---|---|---|---|
| | D3, 2 | D4, 3 | D3, 2 | D4, 3 |
| | (μm) | (μm) | (μm) | (μm) |
| Formula CC | 43.43 | 61.52 | 54.04 | 85.32 |
| (Potato 300) | | | | |
| Formula DD | 32.13 | 54.99 | 54.12 | 86.58 |
| (Potato 200) | | | | |
| Formula EE | 41.16 | 58.84 | 39.63 | 54.15 |
| (Chickpea) | | | | |
| Formula FF | 33.05 | 45.25 | 38.09 | 58.68 |
| (Faba) | | | | |
| Formula GG | 37.33 | 50.28 | 37.92 | 50.96 |
| (Pea) | | | | |

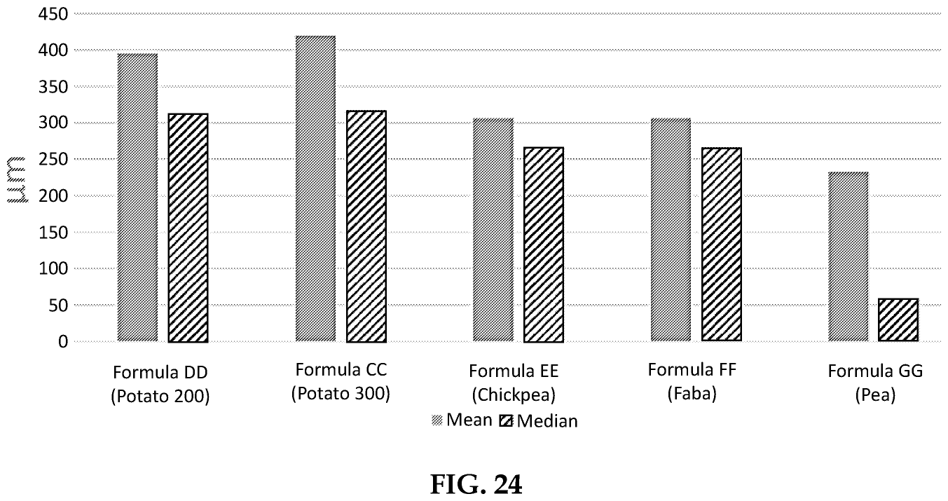

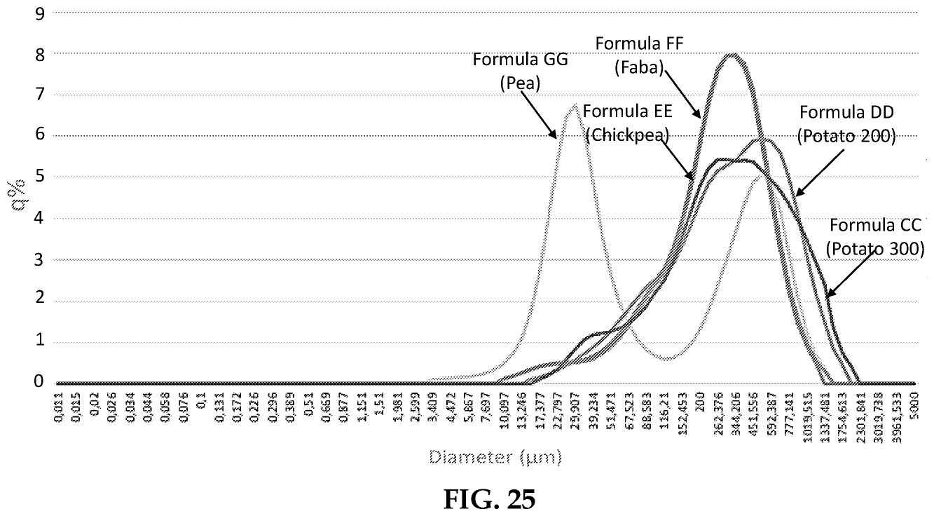

The particle size results (mean and median) for the formulations in Table 18 are presented in FIG. 24 and the particle size distribution data is presented in FIG. 25. Formula FF (faba) and Formula EE (chickpea) showed a similar particle size. Samples prepared with potato protein, Formula CC (potato 300) and Formula DD (potato 200), showed the largest particle sizes. Samples prepared with pea protein (Formula GG) had the smallest mean and median particle sizes.

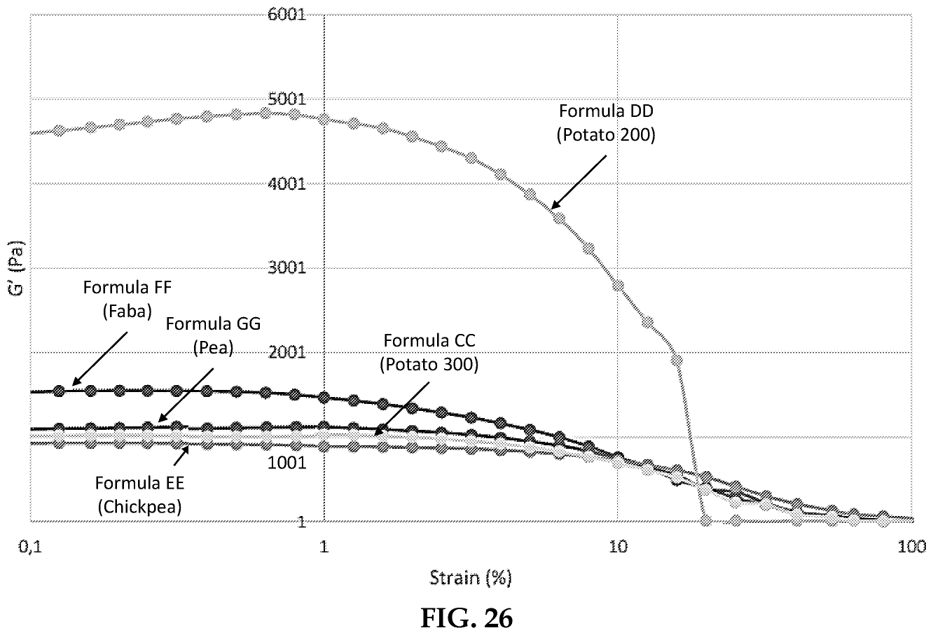

Rheology: The rheology data for the formulations in Table 18 is presented in FIG. 26 and in Table 20 below. Formula DD (potato 200) showed the highest storage modulus, followed by Formula FF (faba). Formula CC (potato 300) showed the longest linear visco-elastic region (LVER).

Viscosity was measured using a Brookfield viscometer HA (spindle 5) at 30 rpm for 30 seconds at 20° C. Two measurements were taken for each formula and the averages are presented in Table 20.

TABLE 20

| | Storage Modulus, | Viscosity |
|---|---|---|
| Sample | G′ (Pa) | (cP) |
| Formula CC (potato 300) | 1023.15 | 14,065 |
| Formula DD (potato 200) | 4729.92 | Over the device |
| | | measurement limit |
| | | of 26,670 |
| Formula EE (chickpea) | 925.57 | 14,120 |
| Formula FF (faba) | 1542 | 16,880 |
| Formula GG (pea) | 1113.6 | 16,385 |

Overall, the emulsion performance data on different plant-based proteins showed that the faba and pea proteins were the best performing proteins. Those samples had good storage modulus values and acceptable oil droplet sizes before and after shaking. Coalescence was observed in samples of Formula DD (potato 200) and Formula EE (chickpea), so those samples are considered unacceptable.

### Example 9

Mayonnaise-type products were also prepared to evaluate the use of gums versus flaxseed fiber on emulsion stability of the finished products. Emulsions prepared with xanthan gum and guar gum were compared to the emulsion of Formula Q (flaxseed fiber) in Table 11 of Example 6. Products including gums were prepared according to the formulations in Table 21 below. The mayonnaise-type products were prepared using the method described in Example 1.

TABLE 21

| | Formula HH: | Formula II: |
|---|---|---|
| | Xanthan Gum | Guar Gum |
| | (wt. %) | (wt. %) |
| Water | 31.05 | 31.05 |
| Lemon juice concentrate | 0.5 | 0.5 |
| Vinegar (19.5%) | 1.0 | 1.0 |
| Sugar | 1.5 | 1.5 |
| Salt | 1.0 | 1.0 |
| Mustard | 2.35 | 2.35 |
| Faba bean protein | 0.6 | 0.6 |
| Rapeseed oil | 60 | 60 |
| Starch | 1.2 | 1.2 |
| Xanthan gum | 0.8 | — |
| Guar gum | — | 0.8 |
| | 100 | 100 |

The samples were analyzed about one week after storage at 20° C. The same analytical techniques described above in Examples 1 and 2 were used to evaluate the formulations in Table 21.

Visual Observation: Results from the visual inspection of Formula HH (xanthan gum) and Formula II (guar gum) before and after shaking are summarized below:
Formula HH (xanthan gum): Before and after shaking, no oil separation was observed.
Formula II (guar gum): Before shaking, no oil separation was observed. After shaking, slight oil separation was observed.

Microscopy: Results from inspection of Formula HH and Formula II under the microscope before and after shaking are summarized below:
Formula HH (xanthan gum): Large globule size was observed before and after shaking, but globule size remained the same before and after shaking.
Formula II (guar gum): Coalescence was observed before and after shaking (considered unacceptable).

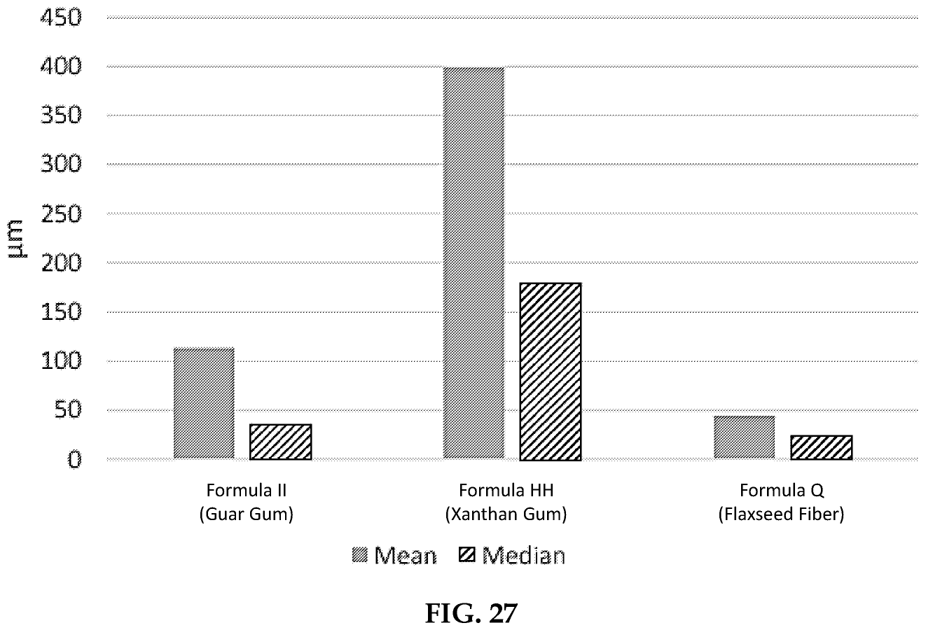

Particle Size: The particle size results (mean and median) for the formulations in Table 21 are presented in Table 22 below. Particle size results are also shown in FIG. 27, and the data for Formula Q (flaxseed fiber) in Table 11 is provided as a reference point. Compared to Formula Q (flaxseed fiber), Formula HH (xanthan gum) showed a significantly higher particle size followed by Formula II (guar gum). The measurements were performed in triplicate and the averages are presented below.

TABLE 22

| | Particle Size Before Shaking | | Particle Size After Shaking | |
|---|---|---|---|---|
| | D3, 2 | D4, 3 | D3, 2 | D4, 3 |
| | (μm) | (μm) | (μm) | (μm) |
| Formula HH | 42.14 | 67.37 | 37.76 | 62.08 |
| (Xanthan | | | | |
| Gum) | | | | |
| Formula II | 21.83 | 28.64 | 23.22 | 30.85 |
| (Guar Gum) | | | | |

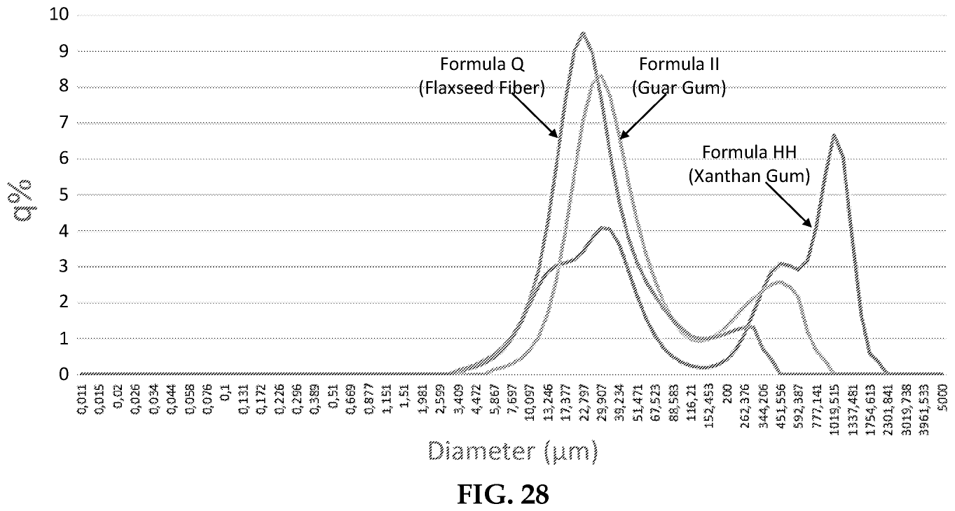

The particle size distribution data for the formulations in Table 21 and Formula Q (flaxseed fiber) from Example 6 is presented in FIG. 28. Formula HH (xanthan gum) showed a multi-modal particle size distribution. Formula II (guar gum) and Formula Q (flaxseed fiber) showed a bimodal particle size distribution. Formula Q (flaxseed fiber) had the smallest particle size.

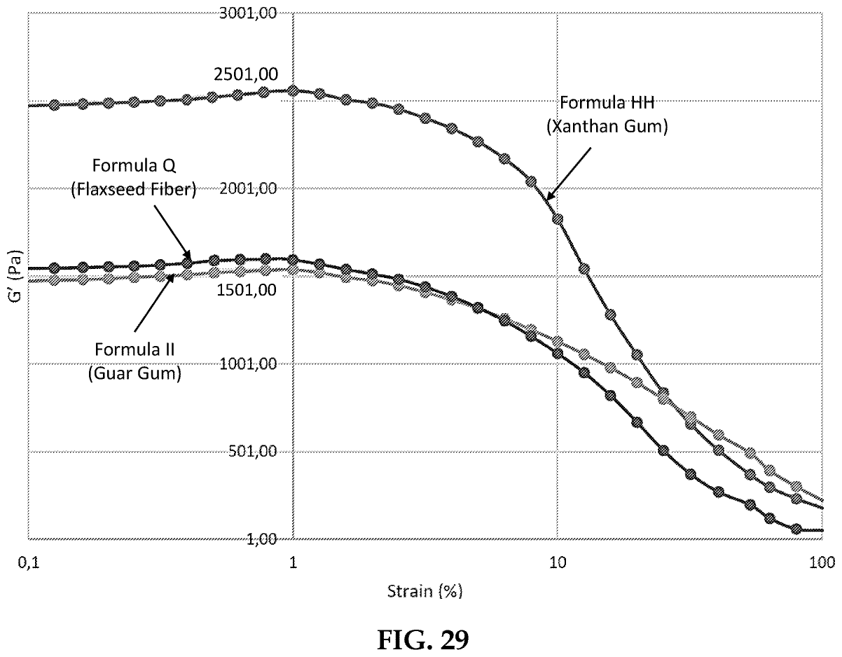

Rheology: The rheology data for the formulations in Table 21 and Formula Q is presented in FIG. 29 and in Table 22 below. Formula HH (xanthan gum) showed the highest storage modulus but the value was unacceptably high. Both gum samples, Formula HH (xanthan gum) and Formula II (guar gum), and the sample with flaxseed fiber (Formula Q) showed a similar visco-elastic region.

Viscosity was measured using a Brookfield viscometer HA (spindle 5) at 30 rpm for 30 seconds at 20° C. Two measurements were taken for each formula and the averages are presented in Table 23.

TABLE 23

| | Storage Modulus, | |
|---|---|---|
| Sample | G′ (Pa) | Viscosity (cP) |
| Formula Q (flaxseed fiber) | 1568.61 | 22,290 |
| Formula HH (xanthan | 2507.5 | Over the device |
| gum) | | measurement limit |
| | | of 26,670 |
| Formula II (guar gum) | 1502.35 | Over the device |
| | | measurement limit |
| | | of 26,670 |

Overall, both formulas with gums were unacceptable. Formula II (guar) showed coalescence. Formula HH (xanthan gum) had too high of a storage modulus.

### Example 10

Mayonnaise-type products were prepared to evaluate the use of increased flaxseed fiber and increased starch in formulations with low oil content (15% oil). The experiment demonstrated that inclusion of the starch and flaxseed fiber were ineffective to stabilize the emulsion at a low oil content.

The formulations in this example were prepared with faba bean protein. The emulsion stability of the finished products was evaluated. Emulsions prepared with increased flaxseed fiber and increased starch were compared to the emulsion of Formula S (faba, low oil) in Table 14 of Example 7. Products including increased flaxseed fiber and increased starch were prepared according to the formulations in Table 24 below. The mayonnaise-type products were prepared using the method described in Example 1.

TABLE 24

| | Formula JJ: | Formula KK: |
|---|---|---|
| | Low Oil, High Flaxseed | Low Oil, High Starch |
| | (wt. %) | (wt. %) |
| Water | 76.45 | 72.75 |
| Lemon juice | 0.5 | 0.5 |
| concentrate | | |
| Vinegar (20%) | 1.0 | 1.0 |
| Sugar | 1.5 | 1.5 |
| Salt | 1.0 | 1.0 |
| Flaxseed fiber | 1.6 | 0.8 |
| Mustard | 2.35 | 2.35 |
| Faba bean protein | 0.6 | 0.6 |
| (Vitessence P360 from | | |
| Ingredion) | | |
| Rapeseed oil | 15 | 15 |
| Starch (Starch | — | 4.5 |
| Novation ® 4300 | | |
| (Ingredion)) | | |
| | 100 | 100 |

The samples were analyzed about one week after storage at 20° C. The same analytical techniques described above in Examples 1 and 2 were used to evaluate the formulations in Table 24.

Visual Observation: Results from the visual inspection of Formula JJ (low oil, high flaxseed) and Formula KK (low oil, high starch) before and after shaking are summarized below:
Formula JJ (low oil, high flaxseed): Before shaking, oil separation was observed. After shaking, oil and phase separation was observed.
Formula KK (low oil, high starch): Before shaking, no oil separation was observed. After shaking, oil separation was observed.

Microscopy: Results from inspection of Formula JJ (low oil, high flaxseed) and Formula KK (low oil, high starch) under the microscope before and after shaking are summarized below:
Formula JJ (low oil, high flaxseed): Before shaking, large globule size was observed that was considered unacceptable. After shaking, coalescence was observed, and the sample was still considered unacceptable.
Formula KK (low oil, high starch): Before shaking, large globule size was observed that was considered unacceptable. After shaking, coalescence was observed, and the sample was still considered unacceptable.

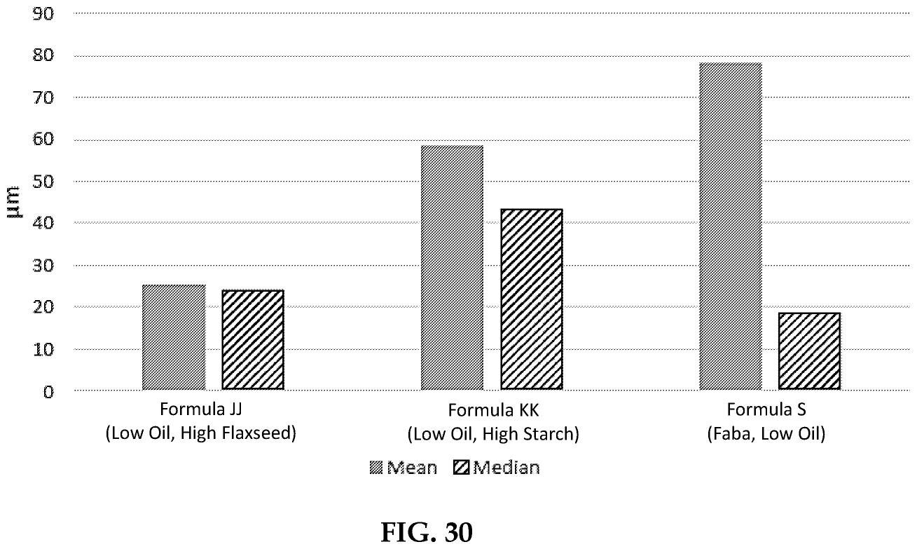

Particle Size: The particle size results (mean and median) for the formulations in Table 24 and for Formula S (faba, low oil) are presented in FIG. 30. Formula S (faba, low oil) showed the largest particle size values and a split emulsion. Formula JJ (low oil, high flaxseed) showed the lowest particle size with phase separation.

The particle size (mean) results for Formula JJ (low oil, high flaxseed) and Formula KK (low oil, high starch) are shown in Table 25 below. The samples were analyzed in triplicate and the averages are presented in the table.

TABLE 25

| | Particle Size Before Shaking | | Particle Size After Shaking | |
|---|---|---|---|---|
| | D3, 2 | D4, 3 | D3, 2 | D4, 3 |
| | (μm) | (μm) | (μm) | (μm) |
| Formula JJ | 18.353 | 25.950 | 42.473 | 64.497 |
| (Low Oil, | | | | |
| High | | | | |
| Flaxseed) | | | | |
| Formula KK | 50.00 | 70.43 | 59.46 | 83.36 |
| (Low Oil, | | | | |
| High Starch) | | | | |

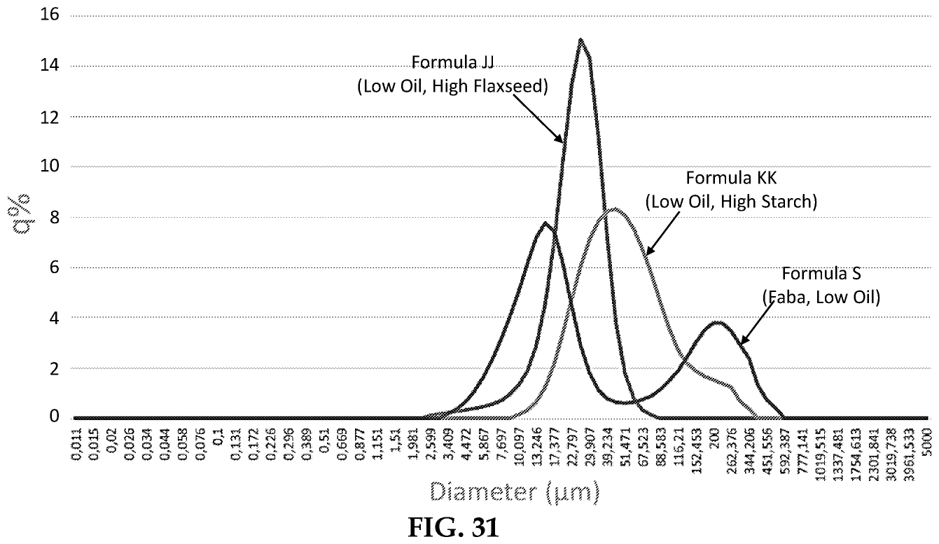

The particle size distribution data for the formulations in Table 24 and Formula S (faba, low oil) is presented in FIG. 31. Formula S (faba, low oil) showed a split emulsion whereas Formula JJ (low oil, high flaxseed) showed phase separation. Formula S (faba, low oil) and Formula KK (low oil, high starch) showed a bimodal particle size distribution. Formula JJ (low oil, high flaxseed) showed a uniform particle size distribution.

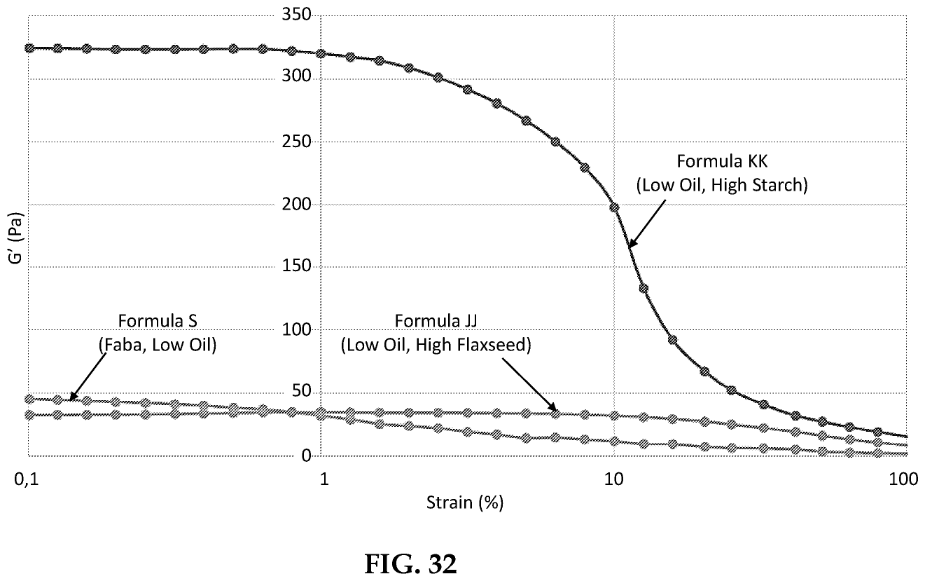

Rheology: The rheology data for the formulations in Table 23 and Formula S (faba, low oil) in Table 11 is presented in FIG. 32 and in Table 26 below. Both Formula S (faba, low oil) and Formula JJ (low oil, high flaxseed) showed a significantly lower storage modulus than Formula KK (low oil, high starch).

Viscosity was measured using a Brookfield viscometer HA (spindle 5) at 30 rpm for 30 seconds at 20° C. Two measurements were taken for each formula and the averages are presented in Table 26.

TABLE 26

| Sample | Storage Modulus, G′ (Pa) | Viscosity (cP) |
|---|---|---|
| Formula S (faba, low oil) | 45.11 | 2933 |
| Formula JJ (low oil, high | 32.34 | 1240 |
| flaxseed) | | |
| Formula KK (low oil, high | 322.11 | 5306.5 |
| starch) | | |

Overall, increasing the flaxseed fiber in Formula JJ including faba bean protein with a low oil content (15% oil) showed phase separation along with coalescence and a low storage modulus. Increasing the starch in Formula KK including faba bean protein and low oil (15% oil) still resulted in visible oil separation after shaking along with coalescence. Therefore, all low oil samples were unacceptable and the increased amount of starch and flaxseed content was unable to provide the necessary stability to the samples.

### Example 12

Mayonnaise-type products were prepared to evaluate the use of different amounts of faba bean protein in formulations with high oil content (80% oil). The emulsion stability of the finished products was evaluated. Emulsions prepared with varying amounts of faba bean protein in high oil were compared to the emulsion of Formula X (faba, high oil) in Table 15 of Example 7. Products including varying amounts of faba bean protein were prepared according to the formulations in Table 27 below. The mayonnaise-type products were prepared using the method described in Example 1.

TABLE 27

| | Formula LL: | Formula MM: | Formula NN: |
|---|---|---|---|
| | High Oil, | High Oil, | High Oil, |
| | 0.2% Faba | 0.4% Faba | 0.8% Faba |
| | (wt. %) | (wt. %) | (wt. %) |
| Water | 12.65 | 12.45 | 12.05 |
| Lemon juice | 0.5 | 0.5 | 0.5 |
| concentrate | | | |
| Vinegar (20%) | 1.0 | 1.0 | 1.0 |
| Sugar | 1.5 | 1.5 | 1.5 |
| Salt | 1.0 | 1.0 | 1.0 |
| Flaxseed fiber | 0.8 | 0.8 | 0.8 |
| Mustard | 2.35 | 2.35 | 2.35 |
| Faba bean protein | 0.2 | 0.4 | 0.8 |
| (Vitessence P360 | | | |
| from Ingredion) | | | |
| Rapeseed oil | 80 | 80 | 80 |
| | 100 | 100 | 100 |

The samples were analyzed about one week after storage at 20° C. The same analytical techniques described above in Examples 1 and 2 were used to evaluate the formulations in Table 27.

Visual Analysis: All of the high oil samples made using the formulations in Table 27 showed a split emulsion.

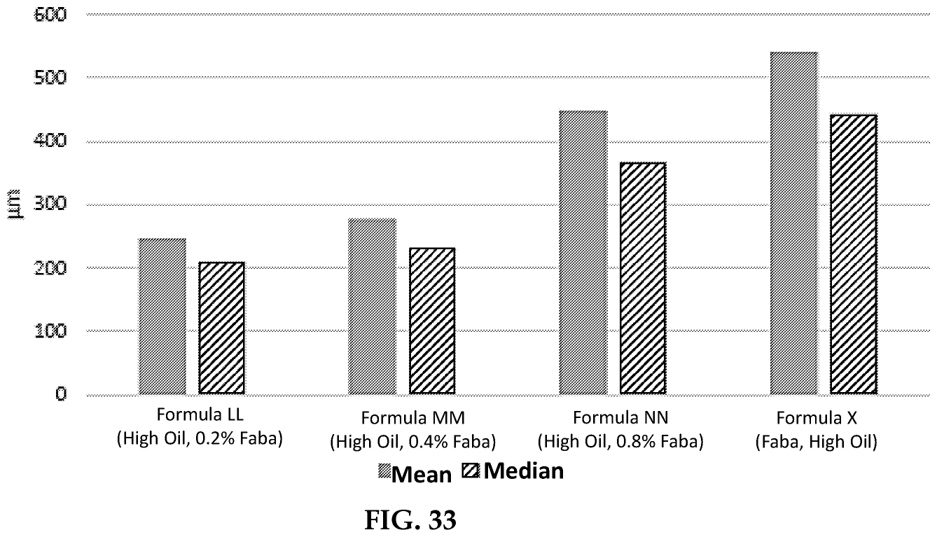

Particle Size: The particle size results (mean and median) for the formulations in Table 27 and for Formula X (faba, high oil) in Table 12 are presented in FIG. 33. Formula X (faba, high oil) showed the largest particle size values.

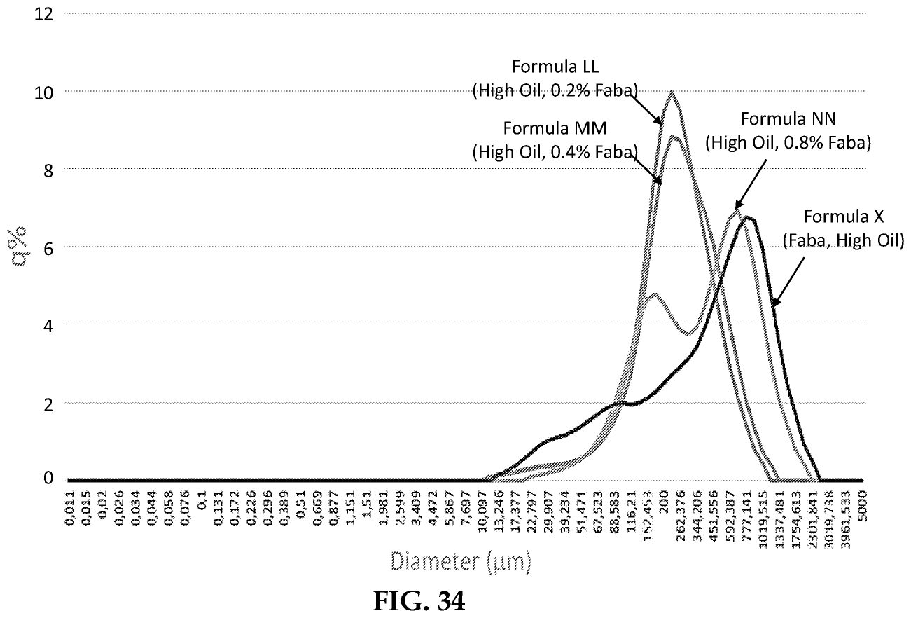

The particle size distribution data for the formulations in Table 26 and Formula X (faba, high oil) is presented in FIG. 34. Each of Formulas LL (high oil, 0.2% faba), Formula MM (high oil, 0.4% faba), and Formula NN (high oil, 0.8% faba) showed a split emulsion.

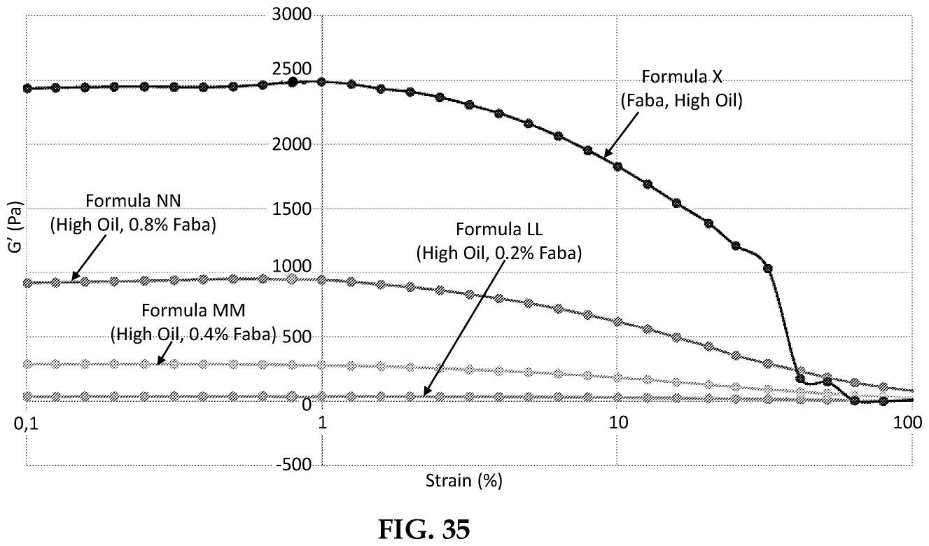

Rheology: The rheology data for the formulations in Table 27 and Formula X (faba, high oil) is presented in FIG. 35 and in Table 28 below. Formula LL (high oil, 0.2% faba) and Formula MM (high oil, 0.4% faba) showed a significantly lower storage modulus and a split emulsion whereas Formula NN (high oil, 0.8% faba) showed a higher storage modulus with a split emulsion. In comparison, Formula X (faba, high oil), which included 0.6 wt. % faba bean protein, showed the highest storage modulus, which was unacceptably high.

Viscosity was measured using a Brookfield viscometer HA (spindle 5) at 30 rpm for 30 seconds at 20° C. Two measurements were taken for each formula and the averages are presented in Table 28.

TABLE 28

| | Storage Modulus, | Viscosity |
|---|---|---|
| Sample | G′ (Pa) | (cP) |
| Formula X | 2451.3 | Over the device |
| (faba, high oil) | | measurement |
| | | limit of 26,670 |
| Formula LL | 36.7 | 333.35 |
| (high oil, 0.2% faba) | | |
| Formula MM | 286.79 | 893.3 |
| (high oil, 0.4% faba) | | |
| Formula NN | 934.82 | 880 |
| (high oil, 0.8% faba) | | |

Overall, Formulas LL, MM, and NN at 80% oil showed split emulsions, and were deemed to be unacceptable. Formula LL (high oil, 0.2% faba) and Formula MM (high oil, 0.4% faba) showed a significantly lower storage modulus and a split emulsion whereas Formula NN (high oil, 0.8% faba) showed a higher storage modulus with a split emulsion.

To further illustrate the present disclosure, aspects are given herein. It is to be understood that these aspects are provided for illustrative purposes and are not to be construed as limiting the scope of the present disclosure.

### ASPECTS

In a first aspect, the present disclosure pertains to an emulsion comprising water; about 15 to about 80% oil; plant-based protein; and plant-based fiber; wherein the emulsion has a mean oil droplet size of less than about 30 microns.

In a second aspect, the present disclosure pertains to the emulsion of the first aspect, wherein the plant-based protein is faba bean protein and the plant-based fiber is flaxseed fiber.

In a third aspect, the present disclosure pertains to the emulsion of the second aspect, wherein the faba bean protein is included in an amount of 0.4 to about 1.5%, the flaxseed fiber is included in an amount of 0.1 to about 1.5%, and the oil is included in amount of about 60 to 80%, all by weight of the emulsion.

In a fourth aspect, the present disclosure pertains to the emulsion of the second aspect, wherein the faba bean protein is included in an amount of 0.1 to about 0.4%, the flaxseed fiber is included in an amount of 3.0 to about 4.0%, and the oil is included in amount of about 15 to 40%, all by weight of the emulsion.

In a fifth aspect, the present disclosure pertains to the emulsion of any one of the first to fourth aspects, wherein the emulsion has a viscosity of about 30,000 to about 60,000 cP when measured at 20 degrees Celsius using a Brookfield Viscometer RV, Spindle 6, at 12 rpm for 30 seconds.

In a sixth aspect, the present disclosure pertains to the emulsion of any one of the first to third and fifth aspects, comprising about 60 to about 75 percent oil.

In a seventh aspect, the present disclosure pertains to the emulsion of any one of the first to third, fifth, and sixth aspects, comprising about 65 to about 75 percent oil.

In an eighth aspect, the present disclosure pertains to the emulsion of any one of the first, second, fourth, and fifth aspects, comprising about 15 to about 40 percent oil.

In a ninth aspect, the present disclosure pertains to the emulsion of any one of the first, second, and fifth aspects, comprising about 40 to about 60 percent oil.

In a tenth aspect, the present disclosure pertains to the emulsion of any one of the first to ninth aspects, wherein the emulsion is free of starch.

In an eleventh aspect, the present disclosure pertains to the emulsion of any one of the first to tenth aspects, wherein the emulsion is free of animal-based emulsifiers.

In a twelfth aspect, the present disclosure pertains to the emulsion of any one of the first to eleventh aspects, wherein the emulsion is free of animal-based protein.

In a thirteenth aspect, the present disclosure pertains to a method for preparing an emulsion, the method comprising: combining plant-based protein, plant-based fiber, and water to provide a first mixture; adding oil to the first mixture to provide a second mixture; and mixing the second mixture to produce an emulsion having a mean oil droplet size of less than about 30 microns.

In a fourteenth aspect, the present disclosure pertains to the method of the thirteenth aspect, further comprising adding an acidulant to the first mixture prior to adding the oil.

In a fifteenth aspect, the present disclosure pertains to the method of the thirteenth or fourteenth aspect, further comprising pasteurizing the first mixture.

In a sixteenth aspect, the present disclosure pertains to the method of any one of the thirteenth to fifteenth aspects, further comprising cooling the pasteurized first mixture prior to adding the oil.

In a seventeenth aspect, the present disclosure pertains to the method of any one of the thirteenth to sixteenth aspects, wherein the plant-based protein is faba bean protein and the plant-based fiber is flaxseed fiber.

In an eighteenth aspect, the present disclosure pertains to the method of the seventeenth aspect, wherein the faba bean protein is included in an amount of 0.4 to about 1.5%, the flaxseed fiber is included in an amount of 0.1 to about 1.5%, and the oil is included in amount of about 60 to 80%, all by weight of the emulsion.

In a nineteenth aspect, the present disclosure pertains to the method of the seventeenth aspect, wherein the faba bean protein is included in an amount of 0.1 to about 0.4%, the flaxseed fiber is included in an amount of 3.0 to about 4.0%, and the oil is included in amount of about 15 to 40%, all by weight of the emulsion.

In a twentieth aspect, the present disclosure pertains to the method of any one of the thirteenth to twentieth aspects, wherein the emulsion has a viscosity of about 30,000 to about 60,000 cP when measured at 20 degrees Celsius using a Brookfield Viscometer RV, Spindle 6, at 12 rpm for 30 seconds.

In a twenty-first aspect, the present disclosure pertains to the method of any one of the thirteenth to eighteenth or twentieth aspects, comprising about 60 to about 75 percent oil.

In a twenty-second aspect, the present disclosure pertains to the method of any one of the thirteenth to eighteenth, twentieth, or twenty-first aspects, comprising about 65 to about 75 percent oil.

In a twenty-third aspect, the present disclosure pertains to the method of any one of the thirteenth to seventeenth, nineteenth, or twentieth aspects, comprising about 15 to about 40 percent oil.

In a twenty-fourth aspect, the present disclosure pertains to the method of any one of the thirteenth to seventeenth, or twentieth aspects, comprising about 40 to about 60 percent oil.

In a twenty-fifth aspect, the present disclosure pertains to the method of any one of the thirteenth to twenty-fourth aspects, wherein the emulsion is free of starch.

In a twenty-sixth aspect, the present disclosure pertains to the method of any one of the thirteenth to twenty-fifth aspects, wherein the emulsion is free of animal-based emulsifiers.

In a twenty-seventh aspect, the present disclosure pertains to the method of any one of the thirteenth to twenty-sixth aspects, wherein the emulsion is free of animal-based protein.

In a twenty-eighth aspect, the present disclosure pertains to an emulsion-based food product comprising the emulsion of any one of the first to twelfth aspects and at least one additional ingredient.

In a twenty-ninth aspect, the present disclosure pertains to the emulsion-based food product of the twenty-eighth aspect, wherein the food product is in the form of one or more of a dressing and mayonnaise-type product.

In a thirtieth aspect, the present disclosure pertains to the emulsion-based food product of the twenty-eighth or twenty-ninth aspect, wherein the at least one additional ingredient comprises one or more of salt, herb, spice, sweetener, and color.

In a thirty-first aspect, the present disclosure pertains to the emulsion-based food product made according to the method of any one of the thirteenth to twenty-seventh aspects and at least one additional ingredient.

In a thirty-second aspect, the present disclosure pertains to the emulsion-based food product according to the thirty-first aspect, wherein the emulsion-based food product is free of starch.

In a thirty-third aspect, the present disclosure pertains to the emulsion-based food product according to the thirty-first or thirty-second aspect, wherein the emulsion-based food product is free of animal-based emulsifiers.

In a thirty-fourth aspect, the present disclosure pertains to the emulsion-based food product according to any one of the thirty-first to thirty-third aspects, wherein the emulsion-based food product is free of animal-based protein.

In a thirty-fifth aspect, the present disclosure pertains to the emulsion according to any one of the first to twelfth aspects, further comprising 0.5% to about 2% starch.

In a thirty-sixth aspect, the present disclosure pertains to the emulsion according to any one of the first to twelfth and thirty-fifth aspects, wherein the starch is a cold water-swelling starch.

In a thirty-seventh aspect, the present disclosure pertains to a plant-based, mayonnaise-type product in the form of an oil-in-water emulsion, the emulsion comprising: water; about 15 to about 80% oil; plant-based protein; and plant-based fiber; wherein the emulsion has a mean oil droplet size of less than about 30 microns.

In a thirty-eighth aspect, the present disclosure pertains to the plant-based, mayonnaise-type product of the thirty-seventh aspect, wherein the plant-based protein is faba bean protein and the plant-based fiber is flaxseed fiber.

In a thirty-ninth aspect, the present disclosure pertains to the plant-based, mayonnaise-type product of the thirty-eighth aspect, wherein the faba bean protein is included in an amount of 0.4 to about 1.5%, the flaxseed fiber is included in an amount of 0.1 to about 1.5%, and the oil is included in amount of about 60 to 80%, all by weight of the emulsion.

In a fortieth aspect, the present disclosure pertains to the plant-based, mayonnaise-type product of the thirty-eighth aspect, wherein the faba bean protein is included in an amount of 0.1 to about 0.4%, the flaxseed fiber is included in an amount of 3.0 to about 4.0%, and the oil is included in amount of about 15 to 40%, all by weight of the emulsion.

In a forty-first aspect, the present disclosure pertains to the plant-based, mayonnaise-type product of any one of the thirty-eighth to fortieth aspects, wherein the emulsion has a viscosity of about 30,000 to about 60,000 cP when measured at 20 degrees Celsius using a Brookfield Viscometer RV, Spindle 6, at 12 rpm for 30 seconds.

In a forty-second aspect, the present disclosure pertains to the plant-based, mayonnaise-type product of any one of the thirty-seventh to thirty-ninth or forty-first aspects, comprising about 60 to about 75 percent oil.

In a forty-third aspect, the present disclosure pertains to the plant-based, mayonnaise-type product of any one of the thirty-seventh to thirty-ninth, forty-first, or forty-second aspects, comprising about 65 to about 75 percent oil.

In a forty-fourth aspect, the present disclosure pertains to the plant-based, mayonnaise-type product of any one of the thirty-seventh, thirty-eight, or forty-first aspects, comprising about 15 to about 40 percent oil.

In a forty-fifth aspect, the present disclosure pertains to the plant-based, mayonnaise-type product of any one of the thirty-seventh, thirty-eight, or forty-first aspects, comprising about 40 to about 60 percent oil.

In a forty-sixth aspect, the present disclosure pertains to the plant-based, mayonnaise-type product of any one of the thirty-seventh to forty-fifth aspects, wherein the emulsion is free of starch.

In a forty-seventh aspect, the present disclosure pertains to the plant-based, mayonnaise-type product of any one of the thirty-seventh to forty-sixth aspects, wherein the emulsion is free of animal-based emulsifiers.

In a forty-eighth aspect, the present disclosure pertains to the plant-based, mayonnaise-type product of any one of the thirty-seventh to forty-seventh aspects, wherein the emulsion is free of animal-based protein.

In a forty-ninth aspect, the present disclosure pertains to the plant-based, mayonnaise-type product of any one of the thirty-seventh to forty-eighth aspects, further comprising 0.5% to about 2% starch.

In a fiftieth aspect, the present disclosure pertains to the plant-based, mayonnaise-type product of any one of the thirty-seventh to forty-ninth aspects, wherein the starch is a cold water-swelling starch.

In a fifty-first aspect, the present disclosure pertains to a method for preparing a plant-based, mayonnaise-type product, the method comprising: combining plant-based protein, plant-based fiber, and water to provide a first mixture; adding oil to the first mixture to provide a second mixture; and mixing the second mixture to produce a plant-based, mayonnaise-type product having a mean oil droplet size of less than about 30 microns.

In a fifty-second aspect, the present disclosure pertains to a method for preparing a plant-based, mayonnaise-type product of the fifty-first aspect, further comprising adding an acidulant to the first mixture prior to adding the oil.

In a fifty-third aspect, the present disclosure pertains to a method for preparing a plant-based, mayonnaise-type product of the fifty-first or fifty-second aspect, further comprising pasteurizing the first mixture.

In a fifty-fourth aspect, the present disclosure pertains to a method for preparing a plant-based, mayonnaise-type product of any one of the fifty-first to fifty-third aspects, further comprising cooling the pasteurized first mixture prior to adding the oil.

In a fifty-fifth aspect, the present disclosure pertains to a method for preparing a plant-based, mayonnaise-type product of any one of the fifty-first to fifty-fourth aspects, wherein the plant-based protein is faba bean protein and the plant-based fiber is flaxseed fiber.

In a fifty-sixth aspect, the present disclosure pertains to a method for preparing a plant-based, mayonnaise-type product of the fifty-fifth aspect, wherein the faba bean protein is included in an amount of 0.4 to about 1.5%, the flaxseed fiber is included in an amount of 0.1 to about 1.5%, and the oil is included in amount of about 60 to 80%, all by weight of the emulsion.

In a fifty-seventh aspect, the present disclosure pertains to a method for preparing a plant-based, mayonnaise-type product of the fifty-fifth aspect, wherein the faba bean protein is included in an amount of 0.1 to about 0.4%, the flaxseed fiber is included in an amount of 3.0 to about 4.0%, and the oil is included in amount of about 15 to 40%, all by weight of the emulsion.

In a fifty-eighth aspect, the present disclosure pertains to a method for preparing a plant-based, mayonnaise-type product of any one of the fifty-first to fifty-seventh aspects, wherein the plant-based, mayonnaise-type product has a viscosity of about 30,000 to about 60,000 cP when measured at 20 degrees Celsius using a Brookfield Viscometer RV, Spindle 6, at 12 rpm for 30 seconds.

In a fifty-ninth aspect, the present disclosure pertains to a method for preparing a plant-based, mayonnaise-type product of any one of the fifty-first to fifty-sixth or fifty-eighth aspects, comprising about 60 to about 75 percent oil.

In a sixtieth aspect, the present disclosure pertains to a method for preparing a plant-based, mayonnaise-type product of any one of the fifty-first to fifty-sixth, fifty-eighth, or fifty-ninth aspects, comprising about 65 to about 75 percent oil.

In a sixty-first aspect, the present disclosure pertains to a method for preparing a plant-based, mayonnaise-type product of any one of the fifty-first to fifty-fifth or fifty-eighth aspects, comprising about 15 to about 40 percent oil.

In a sixty-second aspect, the present disclosure pertains to a method for preparing a plant-based, mayonnaise-type product of any one of the fifty-first to fifty-fifth or fifty-eighth aspects, comprising about 40 to about 60 percent oil.

In a sixty-third aspect, the present disclosure pertains to a method for preparing a plant-based, mayonnaise-type product of any one of the fifty-first to sixty-second aspects, wherein the emulsion is free of starch.

In a sixty-fourth aspect, the present disclosure pertains to a method for preparing a plant-based, mayonnaise-type product of any one of the fifty-first to sixty-third aspects, wherein the emulsion is free of animal-based emulsifiers.

In a sixty-fifth aspect, the present disclosure pertains to a method for preparing a plant-based, mayonnaise-type product of any one of the fifty-first to sixty-fourth aspects, wherein the emulsion is free of animal-based protein.

In a sixty-sixth aspect, the present disclosure pertains to a method for preparing a plant-based, mayonnaise-type product of any one of the fifty-first to sixty-second, sixty-fourth, or sixty-sixth aspects, further comprising 0.5% to about 2% starch.

In a sixty-seventh aspect, the present disclosure pertains to a method for preparing a plant-based, mayonnaise-type product of the sixty-sixth aspect, wherein the starch is a cold water-swelling starch.

While the emulsion-based food products and methods disclosed herein have been described by means of specific embodiments, examples and applications thereof, numerous modifications and variations could be made thereto by those skilled in the art without departing from the scope of the disclosure as set forth in the claims. Unless specified otherwise, all percentages and ratios are by weight.

1. A plant-based, mayonnaise-type product in the form of an oil-in-water emulsion, the emulsion comprising:
water;
about 60 wt. % to about 80 wt. % oil;
0.4 wt. % to about 1.5 wt. % plant-based protein, wherein the plant-based protein includes one or more of faba protein, potato protein, and pea protein; and
0.1 wt. % to about 1.5 wt. % flaxseed fiber.

2. The plant-based, mayonnaise-type product of 1, wherein the emulsion has a viscosity of about 10,000 to about 60,000 cP when measured at 20° Celsius.

3. The plant-based, mayonnaise-type product of claim 1, comprising about 60 wt. % to about 75 wt. % oil.

4. The plant-based, mayonnaise-type product of claim 1, comprising about 65 wt. % to about 75 wt. % oil.

5. The plant-based, mayonnaise-type product of claim 1, wherein the emulsion is free of starch.

6. The plant-based, mayonnaise-type product of claim 1, wherein the emulsion is free of animal-based emulsifiers.

7. The plant-based, mayonnaise-type product of claim 1, further comprising 0.5 wt. % to about 2 wt. % starch.

8. The plant-based, mayonnaise-type product of claim 7, wherein the starch is a cold water-swelling starch.

9. The plant-based, mayonnaise-type product of claim 1, wherein the plant-based protein is faba protein.

10. The plant-based, mayonnaise-type product of claim 1, wherein the plant-based, mayonnaise-type product has a storage modulus (G′ value) of about 1000 to about 2000 Pa.

11. The plant-based, mayonnaise-type product of claim 1, wherein the plant-based protein is included in an amount of about 0.5 wt. % to about 1.0 wt. % by weight of the emulsion.

12. The plant-based, mayonnaise-type product of claim 1, wherein the plant-based, mayonnaise-type product has a storage modulus (G′ value) of about 1200 to about 1800 Pa.

13. A method for preparing a plant-based, mayonnaise-type product in the form of an oil-in-water emulsion, the method comprising:
combining 0.4 wt. % to 1.5 wt. % plant-based protein, 0.1 wt. % to 1.5 wt. % flaxseed fiber, and water to provide a first mixture;
adding 60 wt. % to 80 wt. % oil to the first mixture to provide a second mixture; and
mixing the second mixture to produce an oil-in-water emulsion,
wherein the plant-based protein includes one or more of faba protein, potato protein, and pea protein.

14. The method of claim 13, further comprising adding an acidulant to the first mixture prior to adding the oil.

15. The method of claim 13, further comprising pasteurizing the first mixture.

16. The method of claim 13, wherein the plant-based, mayonnaise-type product has a viscosity of about 10,000 to about 60,000 cP at 20 degrees Celsius.

17. The method of claim 13, comprising about 60 to about 75 percent oil.

18. The method of claim 13, comprising about 65 to about 75 percent oil.

19. The method of claim 13, wherein the plant-based, mayonnaise-type product has a storage modulus (G′ value) of about 1000 to about 2000 Pa.

20. The method of claim 13, wherein the plant-based protein is included in an amount of about 0.5 wt. % to about 1.0 wt. % by weight of the emulsion.
